(19) United States
(12) Patent Application Publication
(10) Pub. No.: US 2002/0123968 A1
(43) Pub. Date: Sep. 5, 2002

(54) Copyright protective device and method

(76) Inventors: Mutsuyuki Okayama, Kyoto (JP); Ryogo Yanagisawa, Osaka (JP); Hideshi Ishihara, Katano (JP)

Correspondence Address: WENDEROTH, LIND & PONACK, L.L.P., 2033 K STREET N. W., SUITE 800, WASHINGTON, DC, 20006-1021, US

(21) Appl. No.: 10/069,795

(22) PCT Filed: Jun. 27, 2001
(86) PCT No.: PCT/JP01/05484

(30) Foreign Application Priority Data
Jun. 29, 2000 (JP) 2000-196080
Jul. 5, 2000 (JP) 2000-203375
Jul. 5, 2000 (JP) 2000-203376

(51) Int. Cl. G06F 17/60

(52) U.S. Cl. 705/57

(57) ABSTRACT

A key generation section 10 generates a key K to be used for cryptographic processing, based on an encrypted key data group EK. A key information retention/selection section 20 retains the generated key and an intermediate key which was obtained when generating the key, and outputs the retained key information in accordance with selection information SEL. The key information is retained, e.g., in a storage circuit within the integrated circuitry, in a form which is not recognizable as a key. A content encryption/decryption section 30 restrains the cryptographic processing result DO from being outputted during key generation. When a heading pattern is detected during the cryptographic processing of an input signal DI, a reset/input enable signal generation circuit 60 switches an input enable signal IE to a disabled state, and outputs a reset signal RST after the cryptographic processing has been completed.

### TECHNICAL FIELD

The present invention relates to a copyright protective device and a copyright protective method. More particularly, the present invention relates to a copyright protective device and a copyright protective method which protect a copyright to a content when processing such as recording, reproduction, transmission, or reception is performed for a content containing data such as sounds and images.

### BACKGROUND ART

Conventionally, data which are contained in a content, e.g., sounds and images, were analog data. When processing such as recording, reproduction, transmission, or reception is performed for analog data, the quality of the data is deteriorated. Therefore, copyright protection for contents has not conventionally been considered a major problem. However, digital technology has seen further advancements in recent years, and it is in wide and general practice to digitalize data which are contained in a content, e.g., text, sounds and images. Even after processing such as recording, reproduction, transmission, or reception is performed for digital data, the quality of the data is hardly deteriorated. Therefore, copyright protection for contents has recently been regarded as a major problem.

In order to solve this problem, various copyright protection techniques have been developed and put to practical use. For example, DES (Data Encryption Standard) encryption, RSA (Rivest Shamir Adleman) encryption, and others, have been put to practical use. Since the details of these encryption techniques are described in, for example, “Gendai Angoriron Nyumon”, edited by the Institute of Electronics, Information, and Communication Engineers, Shinichi IKENO et al., November, 1998, the description thereof are omitted here. Specific examples of copyright protective devices are described in, for example, Japanese Patent Laid-Open Publication No. 8-287014.

In encryption technology, the management of encryption keys (hereinafter referred to as “keys”) for encrypting a content and decrypting the encrypted content is extremely important. Accordingly, in recent years, standards such as CPRM (Content Protection for Recordable Media) and CPPM (Content Protection for Prerecorded Media) have been proposed as techniques for managing keys for contents which are recorded on a recording medium. According to CPRM or CPPM, a plurality of intermediate keys are derived and the derived intermediate keys are subjected to computation processing, whereby a key which is used for the encryption or decryption of a content (hereinafter referred to as a “final key”) is generated. According to CPRM, media keys and media unique keys are employed as intermediate keys, and a title key serves as a final key. According to CPPM, media keys are employed as intermediate keys, and an album unique key serves as a final key.

The details of CPRM and CPPM are described in the following four specification manuals. A first specification manual is “Content Protection for Recordable Media Specification—Introduction and Common Cryptographic Elements”, Revision 0.92, Apr. 18, 2000. A second specification manual is “Content Protection for Recordable Media Specification—DVD Book”, Revision 0.92, Apr. 18, 2000. A third specification manual is “Content Protection for Prerecorded Media Specification—Introduction and Common Cryptographic Elements”, Revision 0.91, Apr. 18, 2000. A fourth specification manual is “Content Protection for Prerecorded Media Specification—DVD Book”, Revision 0.91, Apr. 18, 2000. All of these specification manuals are disclosed to the public.

According to key management techniques such as CPRM and CPPM, the following three problems arise due to performing complicated computation for key generation. A first problem is that, since the key generation processing is complicated, a substantial amount of time is required before a final key can be generated. For example, in order to generate a final key according to CPRM or CPPM, it is necessary to generate a plurality of intermediate keys and perform processing such as authentication and verification. The fact that key generation is time-consuming presents a tremendous problem when a plurality of media are simultaneously mounted on a reproduction device so as to perform random reproduction across the plurality of media. In order to solve this problem, Japanese Patent Laid-Open Publication No. 8-287014 discloses a method of retaining intermediate keys for processing. However, this method is highly problematic in terms of encryption strength because the intermediate keys will appear on local buses in a readable form.

A second problem is that, due to time-consuming key generation, performing an encryption or decryption for a content simultaneously with the key generation will result in incorrect cryptographic processing results being obtained because the key generation cannot finish in time. In other words, even if content data is inputted to a content encryption section during key generation, the content encryption section will generate and output results which are quite different from the expected encryption results. Moreover, even if encrypted content data is inputted to a content decryption section during key generation, the content decryption section is unable to generate correct content data, and will generate and output incorrect results.

With respect to the issue of output control, no method is known which controls an output signal from a copyright protective device in the case where identification information, indicating whether or not to perform an encryption or decryption for a content, is contained in the content data itself. For example, Japanese Patent Laid-Open Publication No. 11-126423 discloses a method which employs a copy bit included in content data as identification information for determining whether copying is permitted or not. According to this method, content data is inputted to a content encryption section or a content decryption section as soon as it is determined whether copying is permitted or not. However, there is a problem in that, in the case where the content encryption section or the content decryption section internally has a function of detecting identification information, encrypted data or decrypted data of a content cannot be outputted because it is impossible to externally input an identification signal to the content encryption section or the content decryption section.

A third problem relates to the signal processing circuitry in a copyright protective device. Digital signal processing circuits are generally designed so as to account for abnormalities such as the occurrence of errors. For example, signal processing circuits are designed so as to regularly perform resetting in order to account for abnormalities as necessary, so that, in the event of an abnormality, it will resume proper operation when proper data is inputted. As an example of such a technique, Japanese Patent Laid-Open Publication No. 7-143489 discloses a method which resets circuitry upon detecting a predetermined code pattern which is contained in data. However, there is a problem in that resetting the circuitry upon detecting the code pattern will result in the erasure of proper data which are stored in storage circuits such as registers within the circuitry, so that it becomes impossible to properly perform signal processing.

With respect to the issue of signal processing circuits, conventional signal processing circuits which control an input signal by using an input enable signal are constructed so as to hold data also in the internal circuitry when the input enable signal becomes inactive. However, conventional signal processing circuits have a problem in that, if data is inputted even after the input enable signal becomes inactive for some reason, any data which are inputted after the input enable signal becomes inactive will be lost.

Therefore, a first object of the present invention is to provide a copyright protective device which rapidly generates an intermediate key or a final key while maintaining encryption strength. Such a copyright protective device will be especially useful when a plurality of media are simultaneously mounted on a reproduction device to perform random reproduction across the media. A second object of the present invention is to provide a copyright protective device which encrypts or decrypts a content with a proper key, without allowing the beginning portion of a content to be lost, together with the key generation. A third object of the present invention is to provide a copyright protective device which, in the case where a code pattern for performing regular resetting is inserted in input data, properly performs resetting and properly operates when proper data is inputted even in the event of an abnormality. Also in connection with the third object, an object of the present invention is to provide a copyright protective device which, in the case where data is inputted after an input enable signal becomes inactive, successfully performs processing without allowing such data to be lost.

### DISCLOSURE OF THE INVENTION

To achieve the above objects, the present invention has the following aspects.

A first aspect of the present invention is directed to a copyright protective device for encrypting or decrypting a content, comprising: key generation means for generating a key with which to apply cryptographic processing to the content,

cryptographic processing means for applying cryptographic processing to the content by using the key, and retention means for retaining, in a form which is not recognizable as a key, at least one of an intermediate key for generating the key and the key.

According to the first aspect as described above, an intermediate key and a key are retained by retention means in a form which is not recognizable as a key to a user. Therefore, by utilizing the generated intermediate key and the generated key, the key generation for the second time or later can be performed in a short period of time. Moreover, since the intermediate key and the key are retained in a form which is not recognizable to a user, the key encryption strength is not undermined.

In this case, the key generation means may generate said key with respect to each of a plurality of media, and the cryptographic processing means may apply cryptographic processing to the content by using the key generated for each medium. As a result, in a device which is capable of mounting a plurality of media, random accessing across a plurality of media can be performed in a short period of time.

Alternatively, the retention means may retain the intermediate key and the key in a storage circuit within integrated circuitry. As a result, the intermediate key and the key can be retained in a manner which is not externally recognizable.

A second aspect of the present invention is directed to a copyright protective device for encrypting or decrypting a content, comprising: key generation means for generating a key with which to apply cryptographic processing to the content, cryptographic processing means for applying cryptographic processing to the content by using the key, and retention means for retaining at least one of an intermediate key for generating the key and the key in an encrypted manner.

According to the second aspect as described above, an intermediate key and a key are retained by retention means in an encrypted fashion. Therefore, by utilizing the generated intermediate key and the generated key, the key generation for the second time or later can be performed in a short period of time. Moreover, since the intermediate key and the key are retained in an encrypted fashion, the key encryption strength can be enhanced. Furthermore, since encrypted keys can be retained in a storage circuit which is external to the integrated circuitry, the number of retained keys is not limited by the amount of storage circuits within the integrated circuitry.

In this case, the key generation means may generate said key with respect to each of a plurality of media, and the cryptographic processing means may apply cryptographic processing to the content by using the key generated for each medium. As a result, in a device which is capable of mounting a plurality of media, random accessing across a plurality of media can be performed in a short period of time, and the key encryption strength can be enhanced.

A third aspect of the present invention is directed to a copyright protective device for encrypting or decrypting a content, comprising: key generation means for generating a key with which to apply cryptographic processing to the content and an intermediate key for generating the key, by sequentially extracting necessary data from key generation data which is formed in a matrix and applying computation processing thereto, cryptographic processing means for applying cryptographic processing to the content by using the key, and retention means for retaining at least one of the intermediate key and the key generation data.

According to the third aspect as described above, an intermediate key and a key are calculated through a complicated algorithm from key generation data which is formed in a matrix, and retained by retention means in a form which is not recognizable as a key to a user. Therefore, by utilizing the generated intermediate key and the generated key, the key generation for the second time or later can be performed in a short period of time even if a complicated key generation algorithm is adopted. Moreover, since the intermediate key and the key are retained in a form which is not recognizable to a user, the key encryption strength is not undermined.

In this case, the key generation means may generate said key with respect to each of a plurality of media, the cryptographic processing means may apply cryptographic processing to the content by using the key generated for each medium, and the retention means may retain the intermediate key and the key generation data with respect to each medium. As a result, in a device which is capable of mounting a plurality of media, random accessing across a plurality of media can be performed in a short period of time, even if a complicated key generation algorithm is adopted.

A fourth aspect of the present invention is directed to a copyright protective method for encrypting or decrypting a content, comprising: a key generation step of generating a key with which to apply cryptographic processing to the content, an cryptographic processing step of applying cryptographic processing to the content by using the key, and a retention step of retaining, in a form which is not recognizable as a key, at least one of an intermediate key for generating the key and the key.

According to the fourth aspect as described above, an intermediate key and a key are retained by a retention step in a form which is not recognizable as a key to a user. Therefore, by utilizing the generated intermediate key and the generated key, the key generation for the second time or later can be performed in a short period of time. Moreover, since the intermediate key and the key are retained in a form which is not recognizable to a user, the key encryption strength is not undermined.

In this case, the key generation step may generate said key with respect to each of a plurality of media, and the cryptographic processing step may apply cryptographic processing to the content by using the key generated for each medium. As a result, in a device which is capable of mounting a plurality of media, random accessing across a plurality of media can be performed in a short period of time.

A fifth aspect of the present invention is directed to a copyright protective method for encrypting or decrypting a content, comprising: a key generation step of generating a key with which to apply cryptographic processing to the content, an cryptographic processing step of applying cryptographic processing to the content by using the key, and a retention step of retaining at least one of an intermediate key for generating the key and the key in an encrypted manner.

According to the fifth aspect as described above, an intermediate key and a key are retained by a retention step in an encrypted fashion. Therefore, by utilizing the generated intermediate key and the generated key, the key generation for the second time or later can be performed in a short period of time. Moreover, since the intermediate key and the key are retained in an encrypted fashion, the key encryption strength can be enhanced. Furthermore, since encrypted keys can be retained in a storage circuit which is external to the integrated circuitry, the number of retained keys is not limited by the amount of storage circuits within the integrated circuitry.

A sixth aspect of the present invention is directed to a copyright protective method for encrypting or decrypting a content, comprising: a key generation step of generating a key with which to apply cryptographic processing to the content and an intermediate key for generating the key, by sequentially extracting necessary data from key generation data which is formed in a matrix and applying computation processing thereto, an cryptographic processing step of applying cryptographic processing to the content by using the key, and a retention step of retaining at least one of the intermediate key and the key generation data.

According to the sixth aspect as described above, an intermediate key and a key are calculated through a complicated algorithm from key generation data which is formed in a matrix, and retained by a retention step in a form which is not recognizable as a key to a user. Therefore, by utilizing the generated intermediate key and the generated key, the key generation for the second time or later can be performed in a short period of time even if a complicated key generation algorithm is adopted. Moreover, since the intermediate key and the key are retained in a form which is not recognizable to a user, the key encryption strength is not undermined.

In this case, the key generation step may generate said key with respect to each of a plurality of media, the cryptographic processing step may apply cryptographic processing to the content by using the key generated for each medium, and the retention step may retain the intermediate key and the key generation data with respect to each medium. As a result, in a device which is capable of mounting a plurality of media, random accessing across a plurality of media can be performed in a short period of time, even if a complicated key generation algorithm is adopted.

A seventh aspect of the present invention is directed to a copyright protective device for encrypting or decrypting a content, comprising: key generation means for generating a key with which to apply cryptographic processing to the content and outputting a notification signal which indicates whether key generation is being performed or not, and cryptographic processing means, to which a content containing identification information indicating whether or not to perform cryptographic processing is inputted, for applying cryptographic processing to the content in accordance with the identification information by using the key, and for outputting a result of the cryptographic processing, wherein the cryptographic processing means restrains the result of the cryptographic processing from being outputted when the notification signal indicates that key generation is being performed.

An eighth aspect of the present invention is directed to a copyright protective device for encrypting or decrypting a content, comprising: key generation means for generating a key with which to apply cryptographic processing to the content and outputting a notification signal which indicates whether key generation is being performed or not, cryptographic processing means, to which a content containing an identification signal indicating whether or not to perform cryptographic processing is inputted, for applying cryptographic processing to the content in accordance with the identification signal by using the key, and for outputting a result of the cryptographic processing, and selection means for selecting a content which is inputted to the cryptographic processing means when the notification signal indicates that key generation is being performed, and otherwise selecting the result of the cryptographic processing outputted from the cryptographic processing means.

According to the seventh and eighth aspects as described above, the results obtained by cryptographic processing means are not outputted to the subsequent processing means during key generation. Therefore, since any results of cryptographic processing obtained by using incorrect keys are not outputted, the subsequent processing means is prevented from being unfavorably affected. The eighth aspect is especially effective in the case of reproducing a disk on which a content which is partially encrypted after being subjected to a high-efficiency encoding is recorded. In this case, since header information for decoding high-efficiency encoding for the content is outputted earlier, if anything, the content can be outputted earlier in the end.

A ninth aspect of the present invention is directed to a copyright protective device for encrypting or decrypting a content, comprising: key generation means for generating a key with which to apply cryptographic processing to the content and outputting a notification signal which indicates whether key generation is being performed or not, and cryptographic processing means, to which a content containing an identification signal indicating whether or not to perform cryptographic processing is inputted, for applying cryptographic processing to the content in accordance with the identification signal by using the key, and for outputting a result of the cryptographic processing, wherein, when the notification signal indicates that key generation is being performed, the cryptographic processing means switches an input enable signal for controlling inputting of contents to an input disabled state.

A tenth aspect of the present invention is directed to a copyright protective device for encrypting or decrypting a content, comprising: key generation means for generating a key with which to apply cryptographic processing to the content, and cryptographic processing means, to which a content containing an identification signal indicating whether or not to perform cryptographic processing is inputted, for applying cryptographic processing to the content in accordance with the identification signal by using the key, and for outputting a result of the cryptographic processing, wherein, when key generation is being performed, the key generation means switches an input enable signal for controlling inputting of contents to an input disabled state.

According to the ninth and tenth aspects as described above, since inputting of contents is disabled during key generation, the results obtained by cryptographic processing means are not outputted to the subsequent processing means. Therefore, since any results of cryptographic processing obtained by using incorrect keys are not outputted, the subsequent processing means is prevented from being unfavorably affected. The ninth and tenth aspects are especially effective for the case of recording a content on a disk in an encrypted manner. In this case, the cryptographic processing means can uninterruptedly output a correct encryption result of a beginning portion of a content, without outputting any incorrect data generated during key generation.

An eleventh aspect of the present invention is directed to a signal processing device for processing an input signal containing per plurality of symbols a heading pattern which represents a heading of a processing unit, comprising: a register for retaining the input signal which is sequentially inputted, heading pattern detection means for detecting the heading pattern being contained in the input signal retained in the register, signal processing means for applying predetermined signal processing to the input signal which is supplied via the register, and notifying whether the input signal is being processed or not, and control signal generation means which outputs a reset signal to the signal processing means if the signal processing means is not performing processing when the heading pattern is detected by the heading pattern detection means, and if the signal processing means is performing processing when the heading pattern is detected by the heading pattern detection means, switches an input enable signal for controlling input to an input disabled state and transitions to a reset-waiting state, and outputs a reset signal to the signal processing means when the processing by the signal processing means is completed in the reset-waiting state.

According to the eleventh aspect as described above, in the case where a code pattern for performing reset on a regular basis is inserted in input data, resetting can be properly performed and properly operation can occur when proper data is inputted, even in the event of an abnormality.

A twelfth aspect of the present invention is directed to a signal processing device for processing an input signal which is inputted symbol by symbol in accordance with an input enable signal, signal processing means to which not more than c symbols of said input signal is inputted after the input enable signal changes to an input disabled state, wherein the signal processing means processes b symbols of said signal at one time and notifies an overflow state of internal processing, input enable signal generation means for switching the input enable signal to an input disabled state when the processing by the signal processing means enters an overflow state, and a register which retains a symbols of said input signal, outputs b symbols to the signal processing means when the input enable signal is in an input enabled state, wherein a, b, and c are of the relationship a≧(b+c), and employs as a load signal a logical OR signal between the input enable signal and a signal obtained by delaying the signal by one clock cycle.

A thirteenth aspect of the present invention is directed to a signal processing device for processing an input signal which is inputted symbol by symbol in accordance with an input enable signal, signal processing means to which not more than c symbols of said input signal is inputted after the input enable signal changes to an input disabled state, wherein the signal processing means applies predetermined processing to the input signal and notifies whether the input signal is acceptable or not, a memory for storing the input signal and outputting the stored input signal to the signal processing means, memory control means which, if the input signal is acceptable to the signal processing means, controls the memory so that the data is read therefrom, and outputs a write address and a read address while performing write control so as not to overwrite data on any unread data, and input enable signal generation means for switching the input enable signal to an input disabled state when a write margin which is calculated based on the write address and the read address outputted from the memory control means reaches at least c symbols.

According to the twelfth and thirteenth aspects as described above, even if data is inputted after an input enable signal becomes inactive, the data can be successfully processed without being lost.

### BRIEF DESCRIPTION OF THE DRAWINGS

FIG. 1 is a block diagram illustrating a structure of a copyright protective device according to a first embodiment of the present invention.

FIG. 2 is a block diagram of a key generation section in a copyright protective device according to an embodiment of the present invention.

FIG. 3 is a block diagram of a key information retention/selection section in a copyright protective device according to an embodiment of the present invention.

FIG. 4 is a block diagram for explaining an output control function of a copyright protective device according to the first embodiment of the present invention.

FIG. 5 is a block diagram for explaining a reset/input control function of a copyright protective device according to the first embodiment of the present invention.

FIG. 6 is another block diagram of a key generation section in a copyright protective device according to an embodiment of the present invention.

FIG. 7 is a figure for comparing reproduction processing times.

FIG. 8 is a data structure diagram of a calculate media key record included in a media key block for copyright protective devices according to fourth to sixth embodiments of the present invention.

FIG. 9 is a data structure diagram of a conditionally calculate media key record included in a media key block for copyright protective devices according to the fourth to sixth embodiments of the present invention.

FIG. 10 is a flowchart illustrating the operation of key information generation and key information retention by copyright protective devices according to the fourth and fifth embodiments of the present invention.

FIG. 11 is a flowchart illustrating the operation of key information generation and key information retention by a copyright protective device according to a sixth embodiment of the present invention.

FIG. 12 is a flowchart illustrating another operation of key information generation and key information retention by a copyright protective device according to the sixth embodiment of the present invention.

FIG. 13 is a block diagram for explaining an output control function of a copyright protective device according to a seventh embodiment of the present invention.

FIG. 14 is a timing chart of output signals from a copyright protective device according to a seventh embodiment of the present invention.

FIG. 15 is a block diagram for explaining an output control function of a copyright protective device according to an eighth embodiment of the present invention.

FIG. 16 is a timing chart of input signals to a copyright protective device according to the eighth embodiment of the present invention.

FIG. 17 is a block diagram for explaining an output control function of a copyright protective device according to a variant of the eighth embodiment of the present invention.

FIG. 18 is a block diagram for explaining an input control function of a copyright protective device according to a ninth embodiment of the present invention.

FIG. 19 is a timing chart of input signals to a copyright protective device according to the ninth embodiment of the present invention.

FIG. 20 is a block diagram for explaining a reset/input control function of a copyright protective device according to a tenth embodiment of the present invention.

FIG. 21 is a block diagram for explaining an input control function of a copyright protective device according to an eleventh embodiment of the present invention.

FIG. 22 is a block diagram for explaining a reset/input control function of a copyright protective device according to a variant of the eleventh embodiment of the present invention.

### BEST MODE FOR CARRYING OUT THE INVENTION

(First Embodiment)

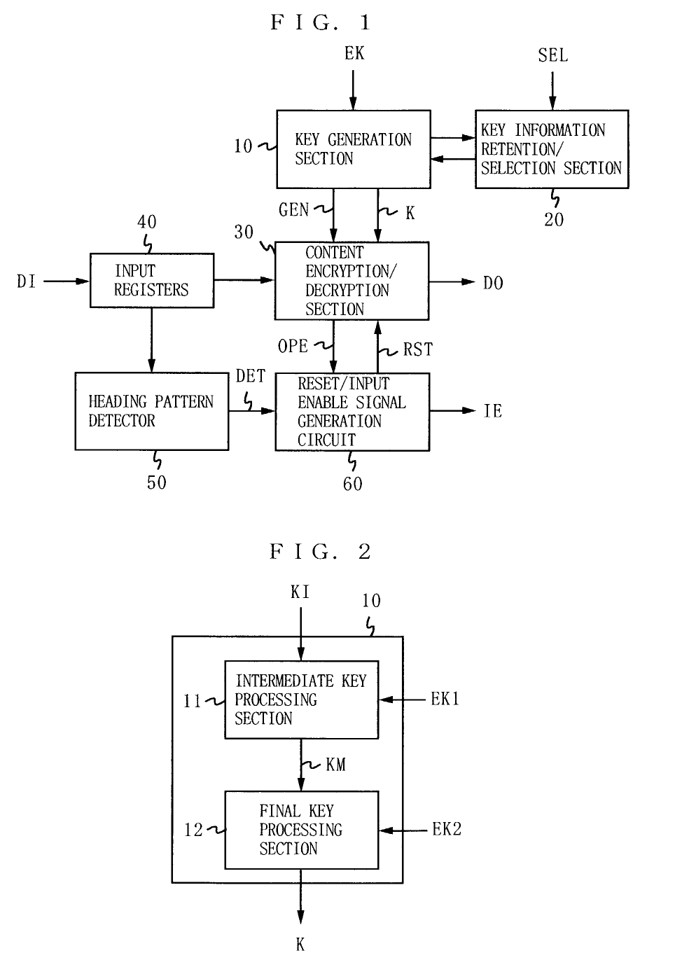

FIG. 1 is a block diagram illustrating a structure of a copyright protective device according to the first embodiment of the present invention. The copyright protective device shown in FIG. 1 comprises a key generation section 10, a key information retention/selection section 20, a content encryption/decryption section 30, input registers 40, a heading pattern detection section 50, and a reset/input enable signal generation circuit 60. The copyright protective device generates key information K, applies encryption processing or decryption processing to input data DI using the generated key information K, and outputs output data DO. Hereinafter, features of the copyright protective device shown in FIG. 1 will be described in connection with the aforementioned three problems (key generation, output control, and reset/input control).

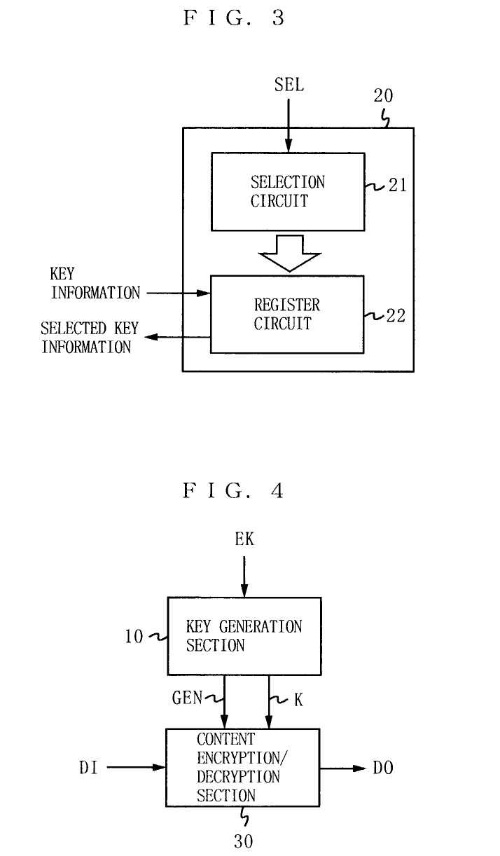

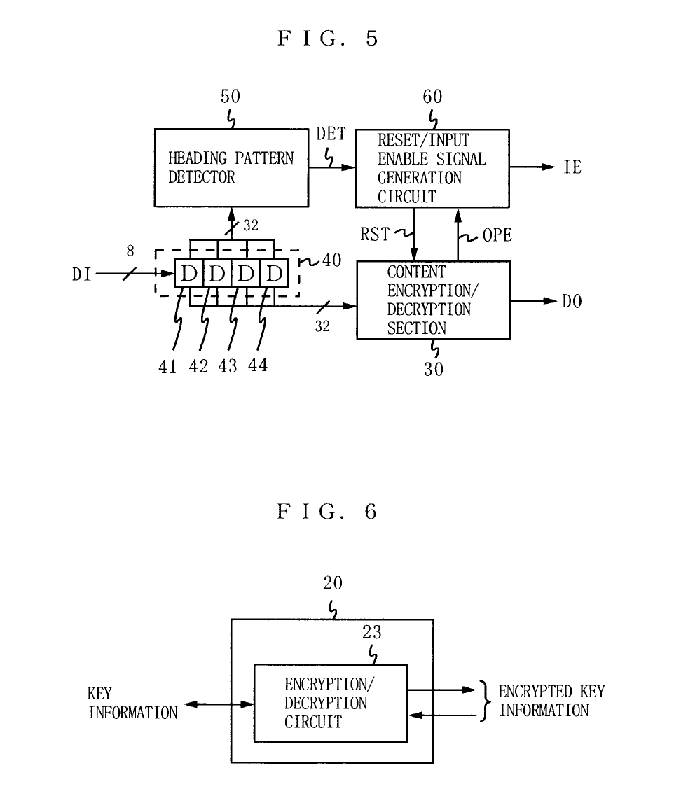

First, a first feature, i.e., reduction of key generation time will be described. FIG. 2 is a block diagram of a key generation section 10. In FIG. 2, the key generation section 10 comprises an intermediate key processing section 11 and a final key processing section 12. FIG. 3 is a block diagram illustrating a structure of the key information retention/selection section 20. In FIG. 3, the key information retention/selection section 20 comprises a selection circuit 21 and a register circuit 22.

In order to facilitate the understanding of the present embodiment, the key generation in a DVD recording/reproduction device will be described as an example. The key generation algorithm illustrated below employs device key A, media key A, media unique key A, title key A, and contents key A. Each apparatus has its own device key. Media key A is encrypted in each device with device key A, and is recorded on a DVD medium. Since a device key is set for each apparatus, a plurality of media keys which have been encrypted with the device keys for respective apparatuses will be recorded on one DVD medium. The plurality of media keys are treated as a key data group.

Media key A which is recorded on a DVD medium in an encrypted fashion is reproduced from the DVD medium, and inputted to the key generation section 10 as an encrypted key data group EK. At this point, it is assumed that device key A has already been inputted to the key generation section 10 by some means. For example, device key A may be previously inputted in a fixed manner, or externally supplied in some sort of converted form and restored by the key generation section 10. The key generation section 10 decrypts the encrypted media key A with device key A to derive media key A. Moreover, a predetermined value a is externally inputted to the key generation section 10 as an encrypted key data group EK. Using the inputted value a, the key generation section 10 converts media key A into media unique key A. Furthermore, an encrypted title key A is inputted to the key generation section 10. The key generation section 10 decrypts the encrypted title key A with media unique key A, thereby deriving title key A.

In connection with FIG. 2, the key generation procedure will be described again. In FIG. 2, device key A is inputted as key information KI, and an encrypted media key A is inputted as an encrypted intermediate key EK1 to the key generation section 10. The intermediate key processing section 11 decrypts the encrypted intermediate key EK1 with the key information KI, thereby deriving media key A as an intermediate key KM. Moreover, a value a is inputted to the key generation section 10 as an encrypted intermediate key EK1. Note that the value a does not need to be actually encrypted. The intermediate key processing section 11 uses the value a to apply conversion to media key A, thereby deriving media unique key A as a new intermediate key KM. Furthermore, an encrypted title key A is inputted to the key generation section 10 as an encrypted final key EK2. The final key processing section 12 decrypts the encrypted title key A with media unique key A, thereby deriving title key A as a final key K.

The derived title key A is inputted to the content encryption/decryption section 30 as the final key K. Using title key A, the content encryption/decryption section 30 performs encryption processing or decryption processing.

On the other hand, the derived media key A, media unique key A, and title key A are supplied to the key information retention/selection section 20, so as to be stored in the register circuit 22 via the selection circuit 21. In the key information retention/selection section 20, the selection circuit 21 operates in accordance with externally-supplied selection information SEL. The selection circuit 21 selects several types of keys stored in the register circuit 22, and outputs them to the key generation section 10. For example, in the case of again decrypting cyphertext data after interrupting the decryption of the cyphertext data, the keys stored in the register circuit 22 may be recalled. Thus, when keys are to be generated for the second time or later, it is only necessary to recall the keys from the storage circuit, so that key information can be generated in a short period of time.

Next, a second feature, i.e., output control during key generation will be described. FIG. 4 shows the key generation section 10 and the content encryption/decryption section 30 out of the block diagram of FIG. 1. The case in which the content encryption/decryption section 30 decrypts input data DI will be described.

As described above, the key generation section 10 outputs title key A to the content encryption/decryption section 30 as the final key K. Cyphertext data DI, which has been derived by encrypting the content, is inputted to the content encryption/decryption section 30. The content encryption/decryption section 30 extracts part of the information from the inputted cyphertext data DI, and uses this to convert title key A into contents key A. Furthermore, based on identification information which is contained in the cyphertext data DI, the content encryption/decryption section 30 determines whether or not to perform decryption. Upon determining that decryption is to be performed, the content encryption/decryption section 30 decrypts the cyphertext data DI with contents key A, and outputs plaintext data DO.

After beginning the generation of intermediate keys such as device key A and media key A and until completing the generation of intermediate keys such as media unique key A and the final key such as title key A, the key generation section 10 outputs a key generation period notification signal GEN, which is kept active, to the content encryption/decryption section 30. While the signal GEN is active, i.e., during key generation, the content encryption/decryption section 30 does not output the plaintext data DO which results from the decryption processing.

Thus, since any results of encryption or decryption obtained by using incorrect keys are not outputted, the subsequent processing means is prevented from being unfavorably affected.

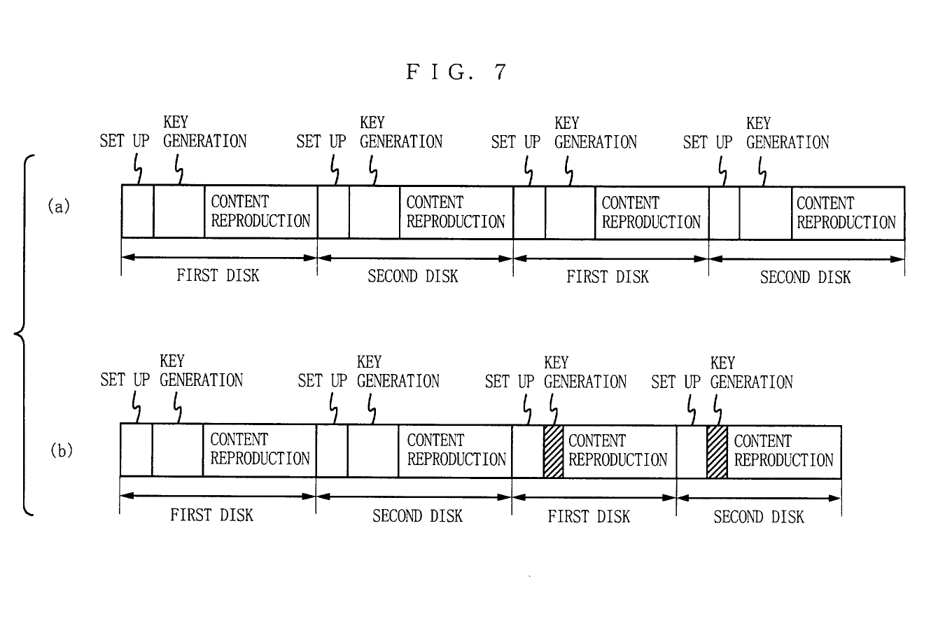

Next, a third feature, i.e., reset/input control will be described. FIG. 5 shows the content encryption/decryption section 30, the input registers 40, the heading pattern detector 50, and the reset/input enable signal generation circuit 60 out of the block diagram of FIG. 1. The input registers 40 include first to fourth registers 41 to 44.

In order to facilitate the understanding of the present embodiment, it is assumed that data is inputted to the copyright protective device shown in FIG. 5 in an 8 bit-parallel manner, in units of 2048 bytes. It is also assumed that a 32-bit heading pattern P is disposed at the beginning of one unit of data. The value of the heading pattern P, which may be arbitrary, is assumed to be, e.g., 000001BA (hexadecimal), in compliance with the DVD recording specification and the format of DVD apparatuses such as DVD video and DVD audio players.

To the copyright protective device shown in FIG. 5, input data DI, composed of units of 2048 bytes, are sequentially inputted byte by byte. The inputted data are sequentially retained in the first to fourth registers 41 to 44. Once four bytes of data have been inputted, the four bytes of input data are simultaneously inputted to the content encryption/decryption section 30 from the first to fourth registers 41 to 44. The content encryption/decryption section 30 performs predetermined processing for the inputted data, and outputs the resulting output data DO. At the same time, the content encryption/decryption section 30 outputs a notification signal OPE which indicates whether or not the circuit itself is in operation, i.e., whether or not the input signal is being processed. The notification signal OPE is inputted to the reset/input enable signal generation circuit 60.

The heading pattern detector 50 monitors the data stored in the first to fourth registers 41 to 44, and outputs a detection signal DET which indicates that a heading pattern P has been detected. The detection signal DET is inputted to the reset/input enable signal generation circuit 60.

If the detection signal DET is received while the notification signal OPE indicates that processing is not being performed, the reset/input enable signal generation circuit 60 outputs a reset signal RST to the content encryption/decryption section 30.

On the other hand, if the detection signal DET is received while the notification signal OPE indicates that processing is being performed, the reset/input enable signal generation circuit 60 turns the input enable signal IE inactive to stop the input signal, thereby transitioning to a reset-waiting state. More specifically, the reset/input enable signal generation circuit 60 internally retains a signal indicating that preparations for a reset have been made. The internal retention of such a signal indicating that preparations for a reset have been made will be referred to as “reset-waiting”.

As the notification signal OPE changes to “processing completed” during the reset-waiting state, the reset/input enable signal generation circuit 60 outputs a reset signal RST to the content encryption/decryption section 30, and cancels the reset-waiting state. If the processing in the content encryption/decryption section 30 enters an overflow state, the reset/input enable signal generation circuit 60 turns the input enable signal IE inactive to stop the input signal.

Thus, resetting is properly made on a regular basis, and even in the event of an abnormality, proper operation can occur when proper data is inputted.

Although the present embodiment illustrates the case of decrypting an encrypted content, a similar constitution can also be adopted in the case of encrypting a content of plaintext data. The key generation algorithm may be one which employs neither media unique key A nor contents key A, or one which employs only one of them. Furthermore, the process of generating title key A may be a more complicated one.

Although the present embodiment assumes that one unit of input data is 2048 bytes, any arbitrary length may be used, e.g., 1024 bytes, 188 bytes, or 194 bytes. Although the heading pattern P is assumed to be a 32-bit 000001BA (hexadecimal), any arbitrary value may be used, e.g., 32-bit 000001BB, 00000100 (hexadecimal), 28-bit 000001e (hexadecimal), or 8-bit 47 (hexadecimal). The content encryption/decryption section 30 may be composed of a plurality of circuit portions.

Hereinafter, other embodiments of the present invention will be described, where second to sixth embodiments relate to the aforementioned first feature; seventh and eighth embodiments relate to the aforementioned second feature; and ninth to eleventh embodiments relate to the aforementioned third feature. Among the constituent elements in the respective embodiments, any constituent elements which are the same as those in the foregoing embodiment will be denoted by the same reference numerals, and the descriptions thereof will be omitted.

(Second Embodiment)

The second embodiment of the present invention is characterized by the structure of the key information retention/selection section 20. FIG. 6 is a block diagram of the key information retention/selection section 20 according to the present embodiment. The key information retention/selection section 20 shown in FIG. 6 comprises an encryption/decryption circuit 23.

In the present embodiment, too, as in the first embodiment, an algorithm is used which employs device key A, media key A, media unique key A, title key A, and contents key A. The key generation section 10 outputs intermediate keys such as media key A and media unique key A and a final key such as title key A to the key information retention/selection section 20. The key information retention/selection section 20 encrypts these keys in the encryption/decryption circuit 23, and outputs the results. The outputting destination from the key information retention/selection section 20 may be, for example, a storage circuit within the integrated circuitry, or a storage circuit external to the integrated circuitry. In the case where it is a storage circuit within the integrated circuitry, a group of circuits such as those shown in FIG. 3 are mounted subsequent to the encryption/decryption circuit 23.

When key information is needed, the necessary key information—out of the key information which is stored in an encrypted fashion in a storage circuit within or external to the integrated circuitry—is read so as to be decrypted by the encryption/decryption circuit 23 and inputted to the key generation section 10.

For example, the case in which media unique key A is retained will be described. It is assumed that media unique key A has been generated through a key generation procedure in the key generation section 10, and inputted to the key information retention/selection section 20. Media unique key A, which has been inputted to key information retention/selection section 20, is encrypted by the encryption/decryption circuit 23, and retained in a storage circuit which is external to the integrated circuitry, for example. Thereafter, when media unique key A is needed, an encrypted media unique key A is read from the storage circuit which is external to the integrated circuitry, and decrypted in the encryption/decryption circuit 23. Media unique key A thus obtained is supplied to the key generation section 10.

Thus, in accordance with the copyright protective device of the present embodiment, when keys are to be generated for the second time or later, the keys can be generated in a shorter period of time than generating the keys in accordance with the procedure provided in the key generation section 10. Moreover, since keys are retained in an encrypted fashion, the key encryption strength can be enhanced relative to the first embodiment. Furthermore, since encrypted keys can be retained in a storage circuit which is external to the integrated circuitry, the number of retained keys is not limited by the amount of storage circuits within the integrated circuitry.

(Third Embodiment)

The third embodiment of the present invention is characterized in that, key information which has been generated for each medium is retained in order to mount a plurality of media. Specifically, the key information retention/selection section 20 retains key information which has been generated with respect to each of a plurality of media.

In order to facilitate the understanding of the present embodiment, a DVD recording/reproduction device which is capable of simultaneously mounting three disks, i.e., first to third disks, is assumed, and the same algorithm as that in the first embodiment is assumed as the key generation algorithm. It is assumed that the key information for the first disk is device key A, media key A, media unique key A, title key A, and contents key A; the key information for the second disk is device key B, media key B, media unique key B, title key B, and contents key B; and the key information for the third disk is device key C, media key C, media unique key C, title key C, and contents key C.

The copyright protective device according to the present embodiment generates key information for the first disk by a method similar to that in the first embodiment. Media key A is recorded on the first disk in a fashion encrypted with device key A. The encrypted media key A is inputted to the key generation section 10 as an encrypted key data group EK. Device key A has already been inputted to the key generation section 10 by some means. For example, device key A may be previously inputted in a fixed manner, or externally supplied in some sort of converted form and restored by the key generation section 10. The key generation section 10 decrypts the encrypted media key A with device key A to derive media key A. Moreover, a predetermined value A_a is externally inputted to the key generation section 10 as an encrypted key data group EK. Using the inputted value A_a, the key generation section 10 converts media key A into media unique key A. Furthermore, an encrypted title key A is inputted to the key generation section 10. The key generation section 10 decrypts the encrypted title key A with media unique key A, thereby deriving title key A.

In connection with FIG. 2, the key generation procedure will be described again. In FIG. 2, device key A is inputted as key information KI, and an encrypted media key A is inputted as an encrypted intermediate key EK1 to the key generation section 10. The intermediate key processing section 11 decrypts the encrypted intermediate key EK1 with the key information KI, thereby deriving media key A as an intermediate key KM. Moreover, a value A_a is inputted to the key generation section 10 as an encrypted intermediate key EK1. The intermediate key processing section 11 uses the value A_a to apply conversion to media key A, thereby deriving media unique key A as a new intermediate key KM. Furthermore, an encrypted title key A is inputted to the key generation section 10 as an encrypted final key EK2. The final key processing section 12 decrypts the encrypted title key A with media unique key A, thereby deriving title key A as a final key K.

The derived title key A is inputted to the content encryption/decryption section 30 as the final key K. Using title key A, the content encryption/decryption section 30 performs encryption processing or decryption processing.

Key information for the second and third disks is also generated by a method similar to that for the first disk. The key information for the respective disks, i.e., media key A, media unique key A, title key A, media key B, media unique key B, title key B, media key C, media unique key C, and title key C, is all supplied to the key information retention/selection section 20, so as to be stored in the register circuit 22 via the selection circuit 21. In the key information retention/selection section 20, the selection circuit 21 operates in accordance with externally-supplied selection information SEL. The selection circuit 21 selects several types of keys stored in the register circuit 22, and outputs them to the key generation section 10. For example, in the case of again reproducing the first disk after the first, second, and third disks have been consecutively reproduced, it is only necessary to recall media unique key A for the first disk.

Thus, in accordance with the copyright protective device of the present embodiment, when keys are to be generated for the second time or later, the keys can be generated by merely recalling them from the storage circuit, so that the keys can be generated in a short period of time. When performing random accessing across a plurality of media in a device which is capable of mounting a plurality of media, it is necessary to generate keys every time the media are switched. Therefore, the effect of reducing the period of time required for one round of key generation becomes particularly outstanding in such a device which performs key generation repeatedly.

With reference to FIG. 7, the effect of reducing the key generation time in accordance with the copyright protective device of the present embodiment will be described. FIG. 7(a) shows a content reproduction processing time of a conventional device. FIG. 7(b) shows a content reproduction processing time of the device of the present embodiment. In both devices, it is assumed that the disks are reproduced in the order of first, second, first, and second, and that the disk must be set up and key generation must be performed prior to reproducing a disk.

In the conventional device (FIG. 7(a)), when reproducing the first disk for a second time after reproducing the second disk, it takes the same amount of time to generate the keys for the first disk as when reproducing the first disk for the first time. This is also the case with reproducing the second disk.

On the other hand, in accordance with the device of the present embodiment (FIG. 7(b)), it takes the same amount of time as in the conventional case to generate the keys for the first and second disks for a first time. However, since the media unique keys for the first and second disks are both retained in the key information retention/selection section 20, it is only necessary to recall the retained media unique keys when the keys are to be generated for the second time or later. Therefore, the period of time required for generating the keys for the second time or later is reduced as compared with the conventional device (hatched portions in FIG. 7(b)).

Although the present embodiment illustrates the case of decrypting an encrypted content, a similar constitution can also be adopted in the case of encrypting a content of plaintext data. The key generation algorithm may be one which employs neither a media unique key (A, B, C) nor a contents key (A, B, C), or one which employs only one of them. Furthermore, the process of generating a title key (A, B, C) may be a more complicated one.

Moreover, the key information retention/selection section 20 may comprise a selection circuit 21 and a register circuit 22 as shown in FIG. 3, or comprise an encryption/decryption circuit 23 as shown in FIG. 6. The copyright protective device in the latter case performs a combined operation of the second and third embodiments. In other words, the key information for the respective disks, i.e., media key A, media unique key A, title key A, media key B, media unique key B, title key B, media key C, media unique key C, and title key C, is retained in a storage circuit external or internal to the integrated circuitry in a fashion encrypted by the encryption/decryption circuit 23 in the key information retention/selection section 20.

According to this method, it is possible to generate keys in a manner which is faster than generating media unique key A in accordance with the procedure provided in the key generation section 10, although slower than retaining it in a storage circuit within the integrated circuitry without performing encryption. Moreover, since media unique key A is retained in an encrypted fashion, the key encryption strength can be enhanced relative to the first embodiment. Furthermore, since encrypted keys can be retained in a storage circuit which is external to the integrated circuitry, the number of retained keys is not limited by the amount of storage circuits within the integrated circuitry. Moreover, the effect of reducing the key generation time becomes particularly outstanding when performing random accessing across a plurality of media in a device which is capable of mounting a plurality of media.

(Fourth Embodiment)

The copyright protective device according to the fourth embodiment of the present invention is characterized in that, in addition to retaining key information, a CPRM or CPPM key generation algorithm is used.

As an example device, a DVD recording/reproduction apparatus will be considered. A DVD recording/reproduction apparatus has a plurality of device keys. To each device key, not only key data, but also row and column information concerning key generation data which are arranged in a matrix is assigned.

According to CPRM, an encrypted key data group is stored in a media key block. A media key block contains the following types of records. A record whose record type value is 81 (hexadecimal) is referred to as a verify media key record. A record whose record type value is 01 (hexadecimal) is referred to as a calculate media key record. A record whose record type value is 82 (hexadecimal) is referred to as a conditionally calculate media key record. Furthermore, 32-bit verification data DEADBEEF (hexadecimal) is referred to as a pattern DB. The verify media key record has recorded therein a result of encrypting the pattern DB with a media key.

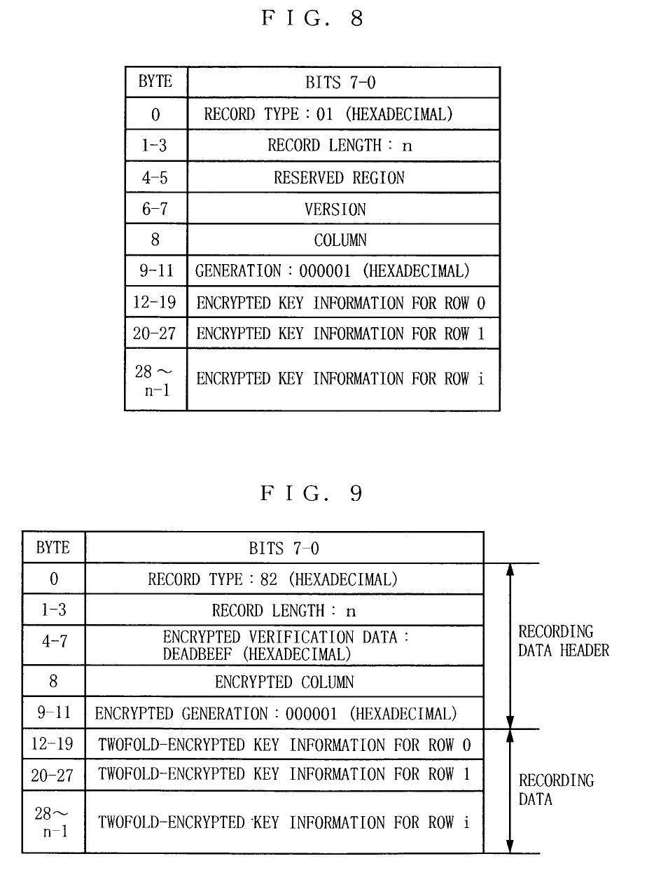

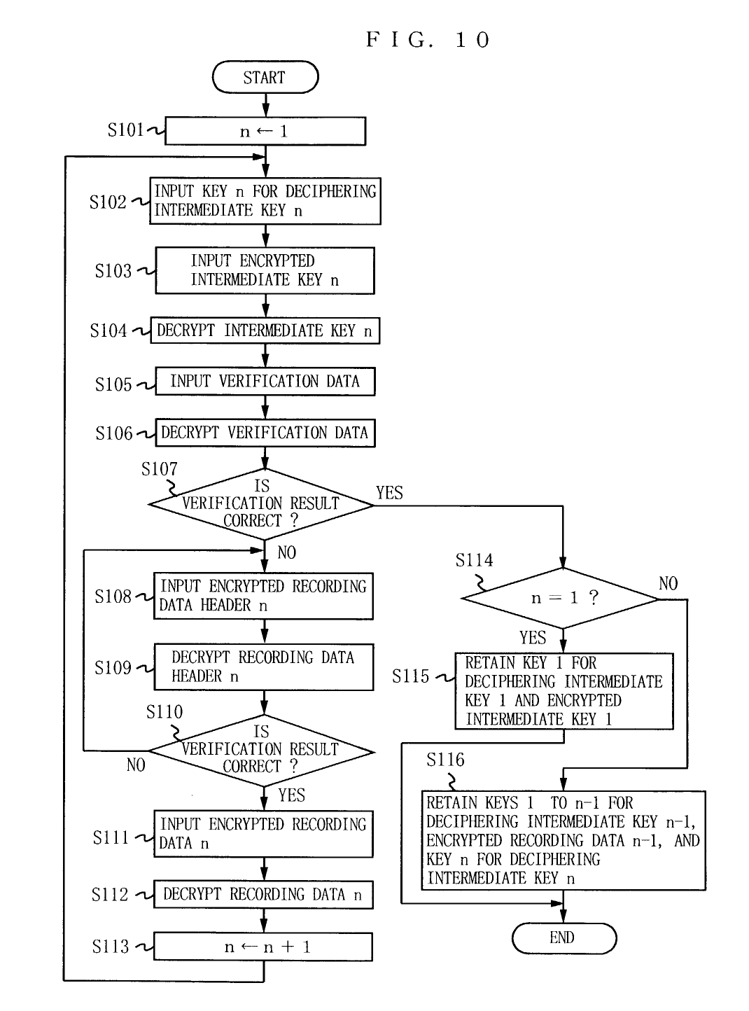

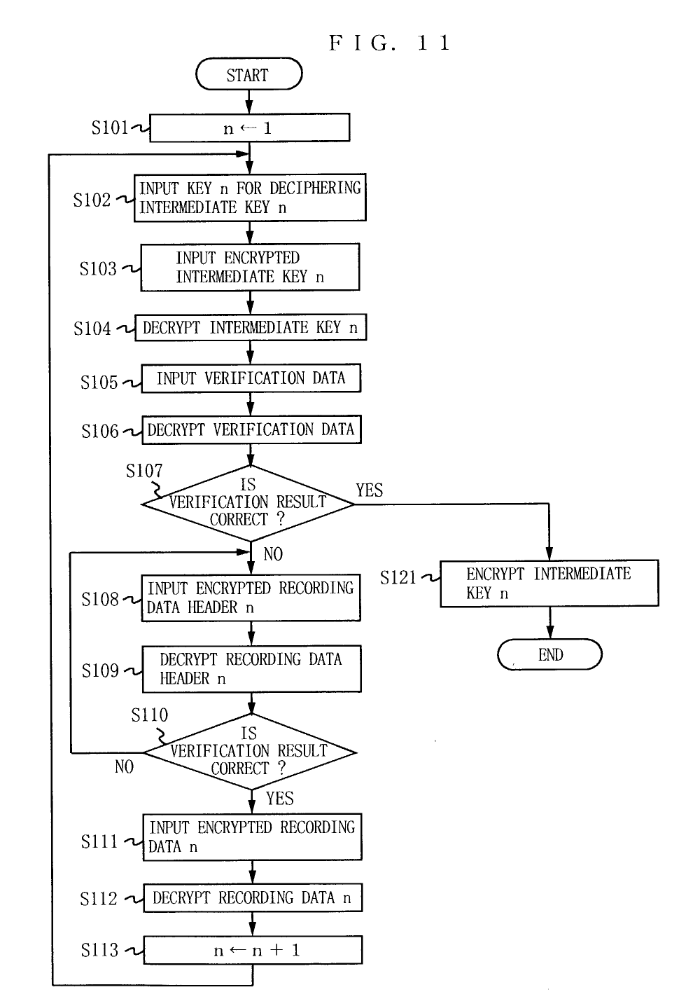

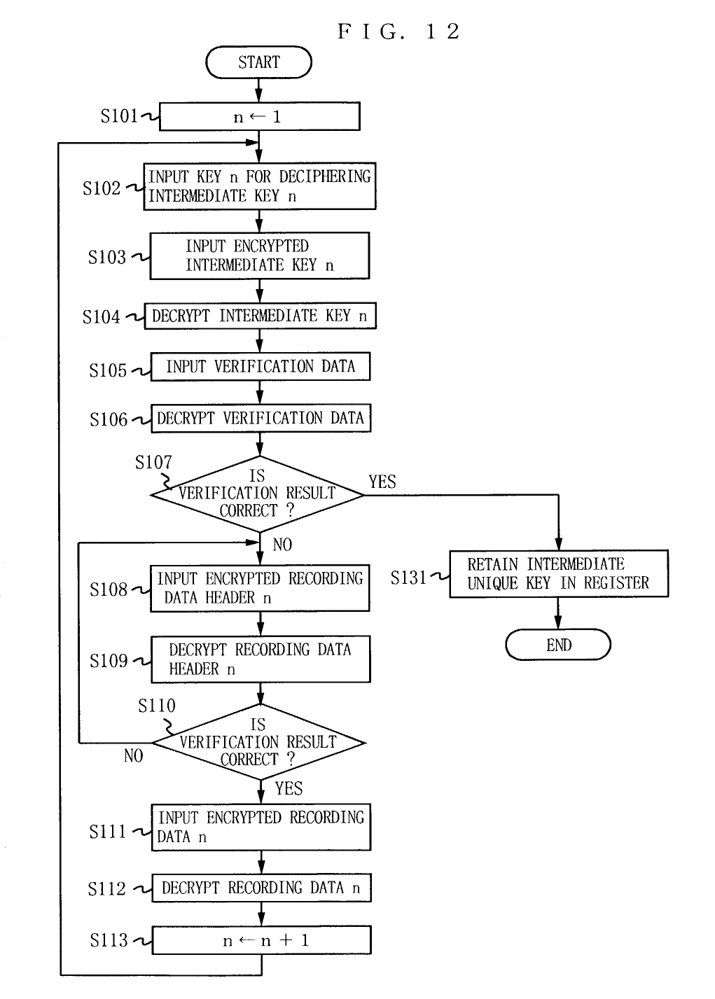

FIG. 8 and FIG. 9 are data structure diagrams of a calculate media key record and a conditionally calculate media key record, respectively, contained in a CPRM media key block. FIG. 10 is a flowchart illustrating the operation of key information generation and key information retention. In this flowchart, media keys are treated as intermediate keys. The details of algorithms and data structures under CPRM and CPPM are described in the aforementioned first to fourth specification manuals, and the descriptions thereof are omitted here.

According to CPRM, media key A and media unique key A are employed as intermediate keys, and title key A is generated as a final key. According to CPPM, media key A is employed as an intermediate key, and album unique key A is generated as a final key.

Hereinafter, with reference to FIG. 10, a processing procedure by the key generation section 10 will be described.

The intermediate keys and final key are stored on a medium in an encrypted fashion. The key generation section 10 first sets the value of a variable n to one (step S101). Note that the variable N is a variable which is used for sequentially processing a plurality of device keys. The plurality of device keys are sequentially labeled as device key A, device key B, device key C, . . . , etc., and media keys corresponding to the respective device keys are sequentially labeled as media key A, media key B, media key C, . . . , etc. As the variable n is sequentially updated from 1 to 2 to 3, . . . , etc., device keys A, B, C, etc., are processed in the alphabetical order and media keys A, B, C, . . . , etc., are generated in the alphabetical order.

Next, device key A for decrypting an encrypted media key A is inputted to the key generation section 10 (step S102). Note that device key A may be inputted in an encrypted fashion. In this case, the key generation section 10 internally decrypts device key A. Next, the encrypted media key A is inputted to the key generation section 10 (step S103). More specifically, the key generation section 10 reads, from the media key block recorded on the medium, encrypted key information corresponding to a row and a column which are assigned to device key A. Next, the key generation section 10 decrypts the encrypted media key A with device key A, thereby obtaining media key A (step S104). However, since the media key thus obtained has not been finalized as media key A at this point, this media key is referred to as a current media key A. In order to obtain a finalized media key A, the key generation section 10 further performs the following processing.

Next, the key generation section 10 reads a verify media key record from the media key block recorded on the medium, and inputs this to itself (step S105). Next, using the current media key A which was derived at step S104, the key generation section 10 decrypts the verify media key record (step S106). As described earlier, a result of encrypting the pattern DB with the media key is recorded in the verify media key record. Therefore, if the pattern DB is obtained by decrypting the verify media key record (YES from step S107), the key generation section 10 regards the current media key A at this point as the correct media key, and proceeds to step S114.

If the pattern DB is not obtained by decrypting the verify key media record (NO from step S107), the key generation section 10 selects a conditionally calculate media key record from the media key block stored on the medium, and inputs this to itself (step S108) Next, the key generation section 10 decrypts the data at byte positions 4 to 11 (recording data header) contained in the conditionally calculate media record with the current media key A (step S109). Next, the key generation section 10 verifies whether or not the data at byte positions 4 to 7 in the decryption result is the pattern DB (step S110). If the decryption result is not the pattern DB, the key generation section 10 returns to step S108. Note that the verification at step S110 is also directed to conditions other than the verification as to whether or not the pattern DB has been obtained. Since the details thereof are described in the aforementioned first to fourth specification manuals, the descriptions thereof are omitted here.

If the decryption result is the pattern DB, the key generation section 10 refers to the decrypted column information (which is recorded at byte position 8 in the recording data header) regards a device key having that column information as device key B, extracts recording data corresponding to the row information of device key B (step S111), and decrypts it with the current media key A (step S112). This means that the recording data, which has been subjected to a twofold encryption, is decrypted at step S112 with respect to one of the encryptions. Next, the key generation section 10 adds one to the variable n (step S113), and returns to step S102.

If the key generation section 10 returns to step S102, the key generation section 10 applies similar processing to the device key which was obtained at step S111. However, since the encrypted current media key B has already been inputted as the encrypted intermediate key at step S112, the key generation section 10 does not perform the process of step S103 in the second round of processing or later.

The key generation section 10 inputs to itself device key B for deciphering media key B (step S102), decrypts an encrypted media key B with device key B (step S104), decrypts a verify key media record with a current media key B (step S106), and if the pattern DB is obtained as a result, regards the current media key B as media key B (step S107).

If the result of verification at step S107 is correct, the current media key is regarded as the correct media key. The key generation section 10 performs computation processing between the derived media key and a media identifier (Media ID), thereby deriving a media unique key (or an album unique key in the case of CPPM). The key generation section 10 decrypts an encrypted title key with the media unique key, and outputs the derived title key to the content encryption/decryption section 30 as a final key K. In the case of CPPM, the key generation section 10 outputs an album unique key, instead of a title key, to the content encryption/decryption section 30 as a final key K.

At step S114 and later, the key information retention/selection section 20 operates. If the variable n is 1 (YES from step S114), the key information retention/selection section 20 retains device key A for deciphering the media key and the encrypted media key A (step S115). If the variable n is not 1 (NO from step S114), the key information retention/selection section 20 retains device keys which have already appeared for deciphering media key n-1, encrypted recording data which is the target of processing at that point, and a device key for deciphering the media key (step S116). For example, in the case where the correct media key was obtained with the second device key, the data from which media key B was obtained, i.e., device key A and the twofold-encrypted key information with which device key B and media key B were obtained are retained. Note that the order of using the device keys must be stored.

Thus, in accordance with the copyright protective device of the present embodiment, even in the case where keys are generated by sequentially extracting necessary data from key generation data which is formed in a matrix and performing computation processing, e.g., under CPRM or CPPM, it is possible to again generate a media key in a short period of time, by retaining a device key (including an encrypted device key) with which a media key as an intermediate key was successfully generated and encrypted media key data.

(Fifth Embodiment)

The fifth embodiment of the present invention differs from the fourth embodiment in that key information which has been generated for each medium is retained in order to mount a plurality of media. According to the present embodiment, an encrypted key data group exists for each medium. Since the present embodiment differs from the fourth embodiment with respect to the processes up to the generation of a title key, these processes will be described below.

In order to facilitate the understanding of the present embodiment, as in the second embodiment, a DVD recording/reproduction device which is capable of simultaneously mounting three disks, i.e., first to third disks, is assumed. As in the fourth embodiment, the copyright protective device according to the present embodiment generates key information for the first disk.

Intermediate keys and a final key are stored on the first disk in an encrypted fashion. Device key A_{—}1 for decrypting an encrypted media key A_{—}1 is inputted to the key generation section 10 (step S102). Note that device key A_{—}1 may be inputted in an encrypted fashion. In this case, the key generation section 10 internally decrypts device key A_{—}1. Next, the encrypted media key A_{—}1 is inputted to the key generation section 10 (step S103). More specifically, the key generation section 10 reads, from the media key block recorded on the medium, encrypted key information corresponding to a row and a column which are assigned to device key A_{—}1. Next, the key generation section 10 decrypts the encrypted media key A_{—}1 with device key A_{—}1, thereby obtaining media key A_{—}1 (step S104). However, since the media key thus obtained has not been finalized as media key A_{—}1 at this point, this media key is referred to as a current media key A_{—}1. In order to obtain a finalized media key A_{—}1, the key generation section 10 further performs the following processing.

Next, the key generation section 10 reads a verify key media record from the media key block recorded on the medium, and inputs this to itself (step S105). Next, using the current media key A—1 which was derived at step S104, the key generation section 10 decrypts the verify key media record (step S106). As described earlier, a result of encrypting the pattern DB with the media key is recorded in the verify key media record. Therefore, if the pattern DB is obtained by decrypting the verify key media record (YES from step S107), the key generation section 10 regards the current media key A_{—}1 at this point as the correct media key, and proceeds to step S114.

If the pattern DB is not obtained by decrypting the verify media record (NO from step S107), the key generation section 10 selects a conditionally calculate media key record from the media key block stored on the medium, and inputs this to itself (step S108). Next, the key generation section 10 decrypts the data at byte positions 4 to 11 (recording data header) contained in the conditionally calculate media record with the current media key A—1 (step S109). Next, the key generation section 10 verifies whether or not the data at byte positions 4 to 7 in the decryption result is the pattern DB (step S110). If the decryption result is not the pattern DB, the key generation section 10 returns to step S108. Note that the verification at step S110 is also directed to conditions other than the verification as to whether or not the pattern DB has been obtained. Since the details thereof are described in the aforementioned first to fourth specification manuals, the descriptions thereof are omitted here.

If the decryption result is the pattern DB, the key generation section 10 refers to the decrypted column information (which is recorded at byte position 8 in the recording data header) regards a device key having that column information as device key A—2, extracts recording data corresponding to the row information of device key A_{—}2 (step S111), and decrypts it with the current media key A_{—}1 (step S112). This means that the recording data, which has been subjected to a twofold encryption, is decrypted at step S112 with respect to one of the encryptions. Next, the key generation section 10 adds one to the variable n (step S113) and returns to step S102.

If the key generation section 10 returns to step S102, the key generation section 10 applies similar processing to the device key which was obtained at step S111. However, since the encrypted current media key A_{—}2 has already been inputted as the encrypted intermediate key at step S112, the key generation section 10 does not perform the process of step S103 in the second round of processing or later.

The key generation section 10 inputs to itself device key A—2 for deciphering media key A_{—}2 (step S102), decrypts an encrypted media key A_{—}2 with device key A_{—}2 (step S104), decrypts a verify media key record with a current media key A_{—}2 (step S106), and if the pattern DB is obtained as a result, regards the current media key A_{—}2 as media key A_{—}2 (step S107).

If the result of verification at step S107 is correct, the current media key is regarded as the correct media key. The key generation section 10 performs computation processing between the derived media key and a media identifier, thereby deriving a media unique key (or an album unique key in the case of CPPM). The key generation section 10 decrypts an encrypted title key with the media unique key, and outputs the derived title key to the content encryption/decryption section 30 as a final key K. In the case of CPPM, the key generation section 10 outputs an album unique key, instead of a title key, to the content encryption/decryption section 30 as a final key K.

At step S114 and later, the key information retention/selection section 20 operates. If the variable n is 1 (YES from step S114), the key information retention/selection section 20 retains device key A_{—}1 for deciphering the media key and the encrypted media key A_{—}1 (step S115). If the variable n is not 1 (NO from step S114), the key information retention/selection section 20 retains device keys which have already appeared for deciphering media key n-1, encrypted recording data which is the target of processing at that point, and a device key for deciphering the media key (step S116). For example, in the case where the correct media key was obtained with the second device key, the data from which media key A_{—}2 was obtained, i.e., device key A_{—}1 and the twofold-encrypted key information with which device key A_{—}2 and media key A_{—}2 were obtained are retained. Note that the order of using the device keys must be stored.

Key information for the second and third disks is also generated by a method similar to that for the first disk, and retained in the key information retention/selection section 20. It will be appreciated that, since the value of the variable n at the time when the processing has reached step S114 differs from disk to disk, the number of units and types of information to be retained differ from disk to disk. For example, it may be possible for device key B_{—}1 and the twofold-encrypted key information with which device key B_{—}2 and media key B_{—}2 were obtained to be retained for the second disk, while device key C_{—}1, device key C_{—}2, and the twofold-encrypted key information with which device key C_{—}3 and media key C_{—}3 were obtained are retained for the third disk.

Thus, in accordance with the copyright protective device of the present embodiment, even in the case where keys are generated by sequentially extracting necessary data from key generation data which is formed in a matrix and performing computation processing, e.g., under CPRM or CPPM, and where the constitution allows a plurality of disks to be mounted, it is possible to again generate a media key in a short period of time by retaining device keys (including encrypted device keys) with which a media key as an intermediate key for each disk was successfully generated and encrypted media key data.

This effect becomes particularly outstanding when performing random accessing across disks. For example, in the case where the disks are consecutively reproduced in the order of first, second, third, second, first, and third, if the aforementioned key information was not retained, it would be necessary to perform a key generation procedure from the beginning every time disks are switched. On the other hand, by retaining encrypted key information and a device key necessary for generating the correct media key as in the present embodiment, it is possible to generate keys in a short period of time by merely recalling the retained information. This effect is similar to that according to the third embodiment, which has already been explained with reference to FIG. 7. Moreover, since the necessary key information is retained in an encrypted fashion, a satisfactory performance is exhibited also in terms of encryption strength.

(Sixth Embodiment)

The sixth embodiment of the present invention is characterized in that intermediate keys which have been generated for respective disks are retained in schemes different from the fifth embodiment. In the case where a first scheme is adopted, the copyright protective device encrypts a generated media key by means of the encryption/decryption circuit 23 and outputs it. In the case where a second scheme is adopted, the copyright protective device retains a generated media key within the integrated circuitry. In the case where a third scheme is adopted, the copyright protective device encrypts a generated media unique key (or an album unique key in the case of CPPM) by means of the encryption/decryption circuit 23 and outputs it. In the case where a fourth scheme is adopted, the copyright protective device retains a generated media unique key (or an album unique key in the case of CPPM) within the integrated circuitry.

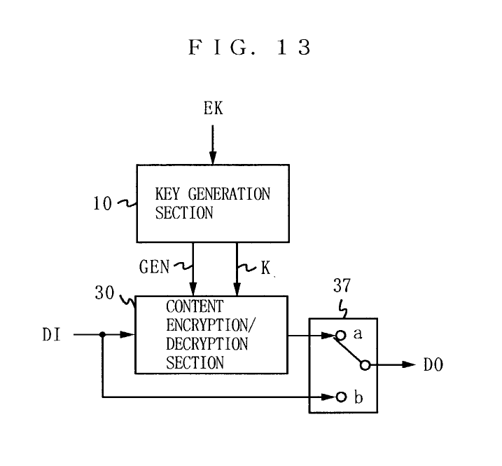

FIG. 11 is a flowchart illustrating the operation of key information generation and key information retention in the case where the first scheme is adopted. FIG. 11 differs from FIG. 10 only with respect to step S121. FIG. 12 is a flowchart illustrating the operation of key information generation and key information retention in the case where the fourth scheme is adopted. FIG. 12 differs from FIG. 10 only with respect to step S131. The processing in each flowchart is similar to that in the fifth embodiment, and the descriptions thereof are omitted here.

Thus, in accordance with the copyright protective device of the present embodiment, even in the case where keys are generated by sequentially extracting necessary data from key generation data which is formed in a matrix and performing computation processing, e.g., under CPRM or CPPM, and where the constitution allows a plurality of disks to be mounted, it is possible to again generate a media key in a short period of time by retaining device keys (including encrypted device keys) with which a media key as an intermediate key for each disk is successfully generated and encrypted media key data. Therefore, this is highly effective when performing random accessing across disks, e.g., in the case where disks are consecutively reproduced in the order of first, second, third, second, first, and third. It will be appreciated that similar effects can be obtained also in the case where a plurality of disks are not mounted.

(Seventh Embodiment)

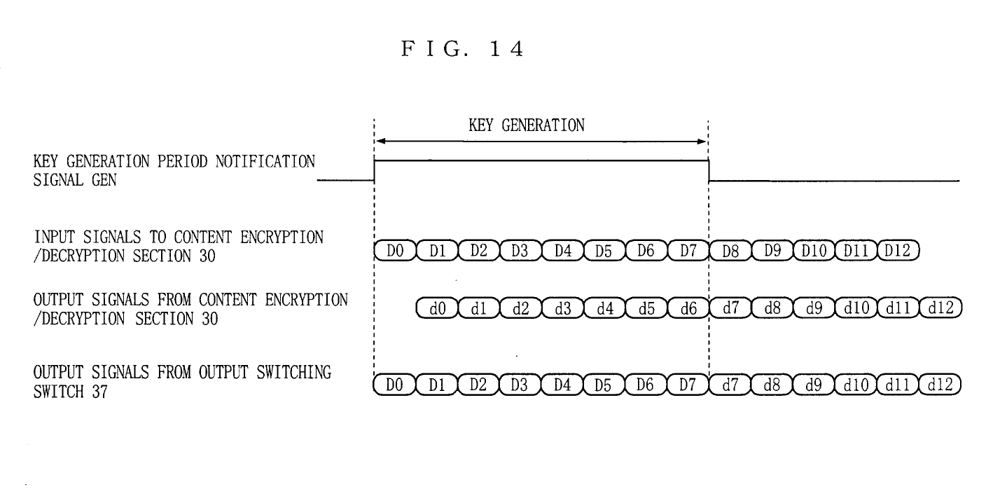

The seventh embodiment of the present invention is characterized in that output control during key generation is performed by employing an output switching switch. FIG. 13 shows a key generation section 10, a content encryption/decryption section 30, and an output switching switch 37 of a copyright protective device according to the present embodiment. FIG. 13 is to be contrasted to FIG. 4.

In the first embodiment, the content encryption/decryption section 30 refrains from outputting the output data DO resulting from cryptographic processing while the key generation period notification signal GEN is active. According to the present embodiment, the output switching switch 37 controls the output data DO.

Specifically, the key generation period notification signal GEN which is outputted from the key generation section 10 is inputted to the output switching switch 37. When the signal GEN is inactive (i.e., not during key generation), the output switching switch 37 selects an output signal (a in FIG. 13) from the content encryption/decryption section 30 for output. On the other hand, when the signal GEN is active (i.e., during key generation), the output switching switch 37 selects an input signal (b in FIG. 13) to the content encryption/decryption section 30 for output.

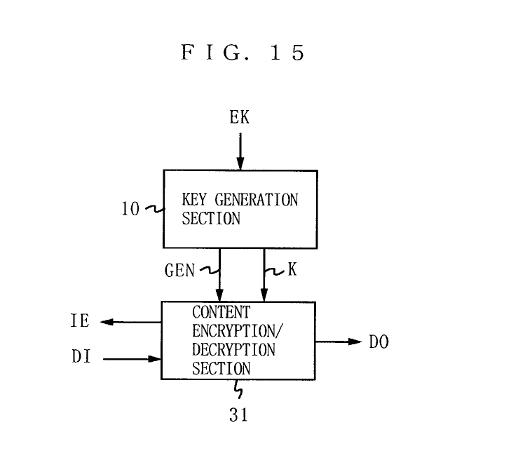

FIG. 14 is a timing chart of input signals to the copyright protective device according to the present embodiment. In FIG. 14, input signals to the content encryption/decryption section 30 are D0, D1, D2, . . . , etc., and output signals from the content encryption/decryption section 30 are d0, d1, d2, . . . , etc. It is assumed that the key generation period notification signal GEN shifts to the H level during key generation.

When the signal GEN is inactive, the output switching switch 37 selects the output signal from the content encryption/decryption section 30 for output. Accordingly, data such as d7, d8, d9, . . . , etc., are outputted from the copyright protective device. On the other hand, when the signal GEN is active, the output switching switch 37 selects the input signal to the content encryption/decryption section 30 and outputs it as it is. Accordingly, data from D0 to D7 are outputted from the copyright protective device.

Thus, in accordance with copyright protective device of the present embodiment, any results of encryption or decryption obtained by using incorrect keys are not outputted, so that the subsequent processing means is prevented from being unfavorably affected.

(Eighth Embodiment)

The eighth embodiment of the present invention is characterized in that data input is disabled during key generation. FIG. 15 shows a key generation section 10 and a content encryption/decryption section 31 of a copyright protective device according to the present embodiment. FIG. 15 is to be contrasted to FIG. 4.

As in the first embodiment, the key generation section 10 outputs title key A to the content encryption/decryption section 31 as a final key K. Title key A and input data DI are inputted to the content encryption/decryption section 31. As in the first embodiment, the content encryption/decryption section 31 encrypts or decrypts input data DI with title key A, and outputs the resulting output data DO.

After beginning the generation of intermediate keys such as device key A and media key A and until completing the generation of intermediate keys such as media unique key A or the final key such as title key A, the key generation section 10 outputs a key generation period notification signal GEN, which is kept active, to the content encryption/decryption section 31. When the signal GEN is active (i.e., during key generation), the content encryption/decryption section 31 outputs an input enable signal IE, which is kept inactive (input disabled state) in order to stop data inputting. On the other hand, when the signal GEN is inactive (i.e., not during key generation), the content encryption/decryption section 31 determines whether or not it is capable of admitting input data DI, and if it is, outputs an input enable signal IE which is kept active (input enabled state). If not, the content encryption/decryption section 31 outputs an input enable signal IE which is kept inactive.

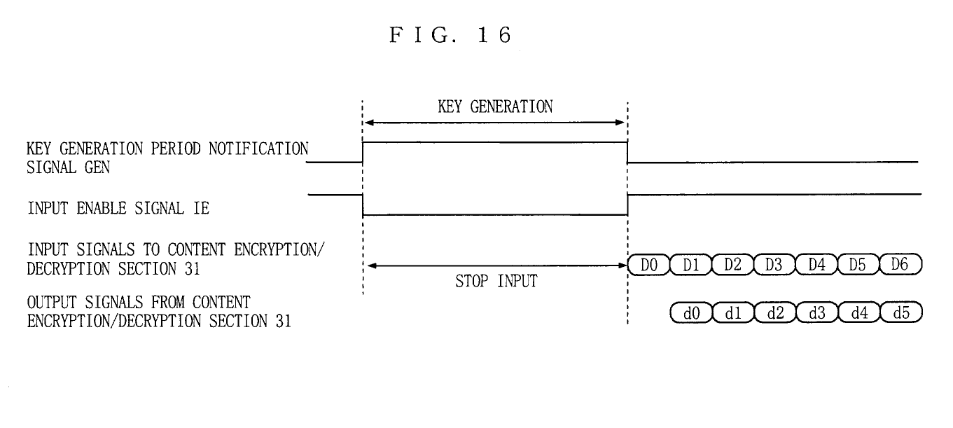

FIG. 16 is a timing chart of input signals to the copyright protective device according to the present embodiment. In FIG. 16, it is assumed that the key generation period notification signal GEN shifts to the H level during key generation, and that the input enable signal IE shifts to the H level during an input enabled state.

As soon as the signal GEN becomes active, the content encryption/decryption section 31 turns the input enable signal IE inactive. As a result, no new data is inputted to the content encryption/decryption section 31 during key generation. Since data input is stopped, the content encryption/decryption section 31 does not output data during this period.

As the signal GEN thereafter becomes inactive, the content encryption/decryption section 31 turns the input enable signal IE active. As a result, data input is restarted. Referring to FIG. 16, as data input is restarted so that data such as D0, D1, D2, . . . , etc., are inputted, data such as d0, d1, d2, . . . , etc., are outputted.

Thus, in accordance with the copyright protective device of the present embodiment, data input is disabled during key generation, so that no data is inputted during key generation. Accordingly, there is provided an effect in that no incorrect data is outputted during key generation.

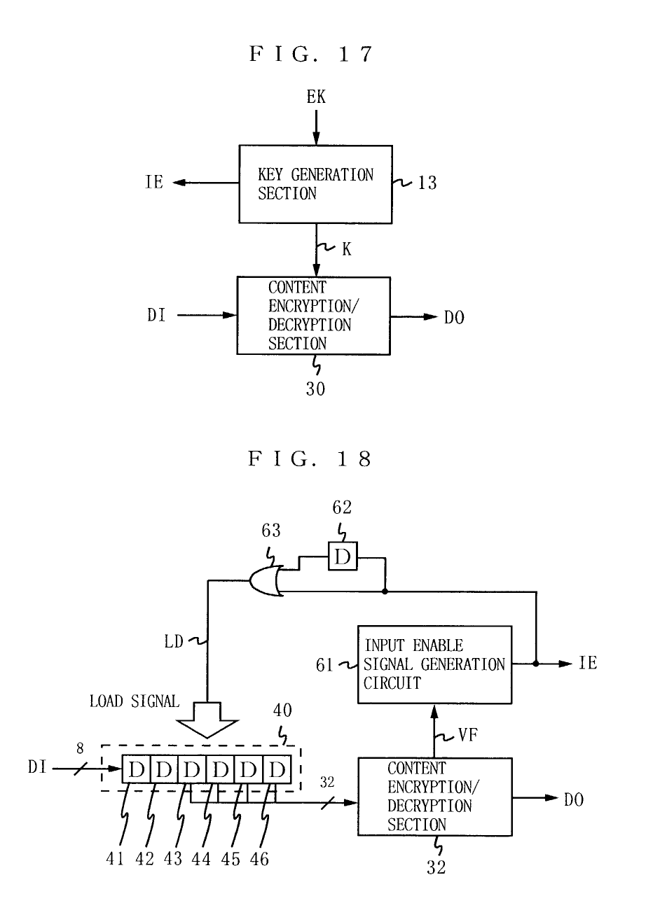

Although the present embodiment illustrates the case where the content encryption/decryption section 31 outputs the input enable signal IE, the key generation section 13 may output the input enable signal IE, as shown in FIG. 17. Such a variant will also attain effects similar to those under the eighth embodiment.

It will be appreciated that, in the case where some other input enable signal is to be outputted from some other constituent element of the copyright protective device, logic computation is to be performed between that signal and the input enable signal which is outputted from the content encryption/decryption section or the key generation section, to derive an input enable signal to be externally outputted.

(Ninth Embodiment)

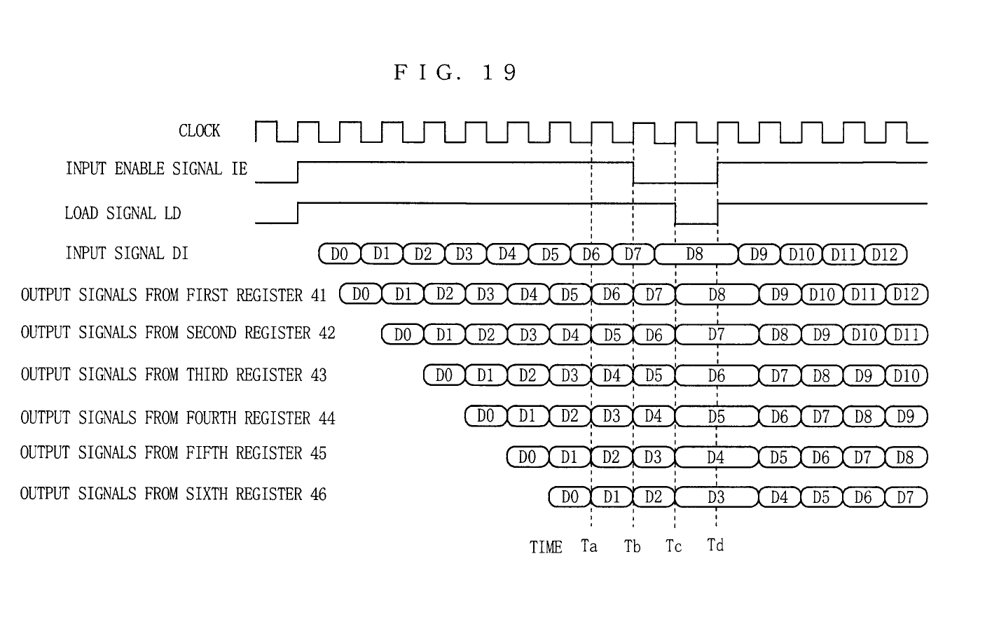

FIG. 18 shows a content encryption/decryption section 32, input registers 40, an input enable signal generation circuit 61, a register 62, and a logical OR circuit 63 of a copyright protective device according to the ninth embodiment of the present invention. The input registers 40 include first to sixth registers 41 to 46. FIG. 18 is to be contrasted to FIG. 5.

The first embodiment aims at performing resetting on a regular basis so that proper operation can occur when proper data is inputted, even in the event of an abnormality. The present embodiment aims at ensuring that, even if data is inputted after the input enable signal becomes inactive (input disabled state), the data which was inputted after the input enable signal became inactive (hereinafter referred to as “excessive data”) is successfully processed without being lost.

In order to facilitate the understanding of the present embodiment, it is assumed that data is inputted byte by byte to the content encryption/decryption section 32, and that one byte of excessive data is inputted after the input enable signal IE becomes inactive. The input data are sequentially retained in the first to sixth registers 41 to 46. Four bytes of data which are outputted from the third to sixth registers 43 to 46 are simultaneously inputted to the content encryption/decryption section 32. The content encryption/decryption section 32 applies predetermined processing to the inputted data, and outputs a result thereof. Moreover, the content encryption/decryption section 32 detects that an overflow will occur in its internal processing, and outputs a notification signal VF in an immediately previous clock cycle to the occurrence of an overflow to indicate the occurrence of an overflow.

Although the specific circumstances behind the occurrence of an overflow in the content encryption/decryption section 32 and the method for detecting overflow do not constitute features of the present invention, an overflow may occur in the following case, for example. That is, although the content encryption/decryption section 32 retains input signals in the registers and performs computation processing at a constant speed, the data inputting speed may exceed the processing speed of the content encryption/decryption section 31 if the data inputting speed is variable. In such cases, an overflow occurs in the registers of the content encryption/decryption section 31.

The overflow notification signal VF is inputted to the input enable signal generation circuit 61. Upon receiving the signal VF, the input enable signal generation circuit 61 outputs an input enable signal IE which is kept inactive (input disabled state). Under the aforementioned assumption, when the input enable signal IE becomes inactive, data input is stopped but one byte of excessive data is inputted.

The first to sixth registers 41 to 46 are all controlled by a load signal LD. As shown in FIG. 18, the load signal LD is a signal which is obtained by taking a logical OR in the logical OR circuit 63 between the input enable signal IE and a signal which is obtained by delaying the signal IE by one clock cycle in the register 62. The load signal LD will remain active one clock cycle longer than the input enable signal IE. Therefore, the first to sixth registers 41 to 46 further load one byte of input data DI after the input enable signal IE becomes inactive. Thus, the one byte of excessive data which was inputted after the input enable signal IE became inactive is loaded into the first register 41.

FIG. 19 is a timing chart of input signals to the copyright protective device according to the present embodiment. In FIG. 19, the content encryption/decryption section 31 detects that its internal processing will overflow at time Ta, and at time Tb which follows one clock cycle later, outputs an input enable signal IE which is kept inactive. Since data D7 is inputted at time Tb, the copyright protective device must take this in. Since the load signal LD is active at time Tb, the data D7 is successfully taken into the first register 41.

Although the input enable signal IE becomes inactive at time Tb, one byte of excessive data D8 is inputted. Since the load signal LD is still active at time Tc, the data D8 is successfully taken into the first register 41. Thereafter, the overflow state of the content encryption/decryption section 31 disappears, and as the input enable signal IE becomes active at time Td, data such as D9, D10, D11 . . . , etc., are inputted at time Td and later. These data will also be sequentially taken into the first register 41.

As shown in FIG. 19, even if the input enable signal IE becomes inactive part of the way, and one byte of excessive data is inputted after the input enable signal IE has become inactive, no data loss occurs in the output signals from the third to sixth registers 43 to 46, which are inputted to the content encryption/decryption section 32. As a result, the content encryption/decryption section 32 can properly process the inputted data without allowing it to be lost.

Thus, in accordance with the copyright protective device of the present embodiment, even if data is inputted after the input enable signal becomes inactive, the excessive data can be successfully processed without being lost.

Although the present embodiment assumes that data is inputted byte by byte, and one byte of excessive data is inputted, the unit of input data and the number of excessive data may be arbitrary. In the case where the number of excessive data is two or more, the number of stages of the input registers and the extended period for the input enable signal IE may be adjusted in accordance with the number of excessive data.

(Tenth Embodiment)

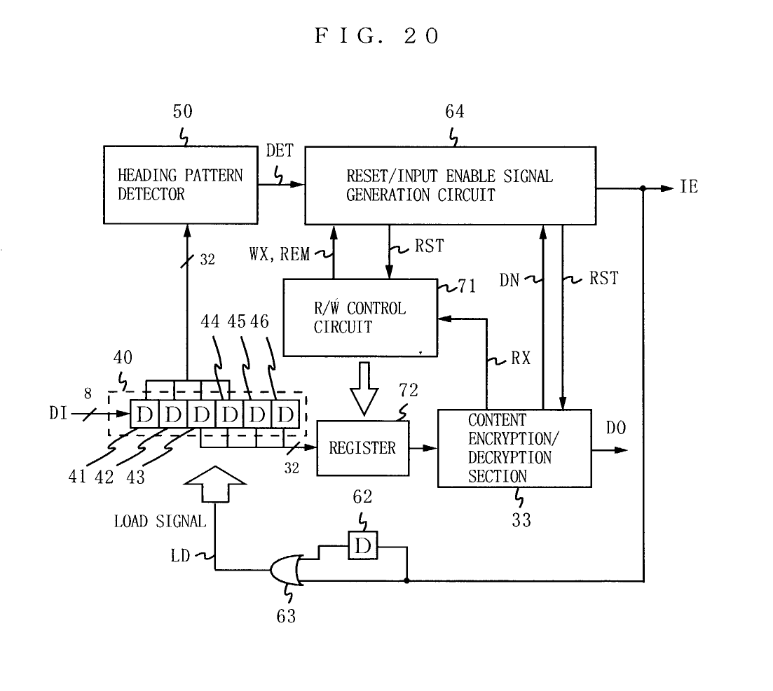

FIG. 20 shows a content encryption/decryption section 33, input registers 40, a heading pattern detector 50, a register 62, a logical OR circuit 63, a reset/input enable signal generation circuit 64, a R/W control circuit 71, and a register 72 of a copyright protective device according to the tenth embodiment of the present invention. The input registers 40 include first to sixth registers 41 to 46. FIG. 20 is to be contrasted to FIG. 5.

According to the present embodiment, the content encryption/decryption section 30 shown in FIG. 5, or the content encryption/decryption section 32 shown in FIG. 18, is subdivided into the R/W control circuit 71, the register 72, and the content encryption/decryption section 33. In the ninth embodiment, data which are stored in the third to sixth registers 43 to 46 are outputted when the input enable signal IE is active. The present embodiment is characterized in that the write enable conditions in the R/W control circuit 71 additionally stipulate that the input enable signal IE be active.

In order to facilitate the understanding of the present embodiment, it is assumed that, as in the first embodiment, data is inputted to the copyright protective device shown in FIG. 20 in an 8 bit-parallel manner, in units of 2048 bytes. It is also assumed that a 32-bit heading pattern P is disposed at the beginning of one unit of data.

To the copyright protective device shown in FIG. 20, input data DI, composed of units of 2048 bytes, are sequentially inputted byte by byte. The inputted data are sequentially retained in the first to sixth registers 41 to 46. The outputs from the third to sixth registers 43 to 46 are written to the register 72 under the control of the R/W control circuit 71. If there is a writable region in the register 72, the R/W control circuit 71 enables writing to the register 72. Moreover, if there is any data in the register 72 that has not been read yet, the R/W control circuit 71 reads such data from the register 72, and outputs it to the content encryption/decryption section 33. Furthermore, the R/W control circuit 71 disables writing to data regions in the register 72 which have not been read yet, and outputs a write disablement notification signal WX, which indicates that writing is disabled. In addition, the R/W control circuit 71 outputs a residual unread data notification signal REM, which indicates that there is data in the register 72 that has not been read. The notification signals WX and REM are inputted to the reset/input enable signal generation circuit 64.

The output from the register 72 is inputted to the content encryption/decryption section 33. The content encryption/decryption section 33 applies predetermined processing to the inputted data, and outputs the result thereof. Moreover, the content encryption/decryption section 32 outputs a read stop signal RX if its internal processing overflows. Furthermore, the content encryption/decryption section 32 outputs a processing completion signal DN, which indicates that no data that is under processing is left therein. The read stop signal RX is inputted to the R/W control circuit 71, and the processing completion signal DN is inputted to the reset/input enable signal generation circuit 64.

Upon receiving the write disablement notification signal WX, the reset/input enable signal generation circuit 64 immediately outputs an input enable signal IE which is kept inactive (input disabled state) to stop data input. The operation after the input enable signal IE becomes inactive is the same as that under the ninth embodiment, and the descriptions thereof are omitted here.

The heading pattern detector 50 monitors the data stored in the first to fourth registers 41 to 44, and outputs a detection signal DET which indicates the detection of a heading pattern P. The detection signal DET is inputted to the reset/input enable signal generation circuit 64.

If the reset/input enable signal generation circuit 64 receives the detection signal DET while the notification signal REM indicates “there is no unprocessed data” and the processing completion signal DN indicates “processing completed”, the reset/input enable signal generation circuit 64 outputs a reset signal RST to the R/W control circuit 71 and the content encryption/decryption section 33.

On the other hand, if the reset/input enable signal generation circuit 64 receives the detection signal DET while the notification signal REM indicates “there is unprocessed data” or while the processing completion signal DN indicates that processing is uncompleted, the reset/input enable signal generation circuit 64 outputs an input enable signal IE which is kept inactive to stop data input, and transitions to a reset-waiting state. The definition and operation of reset-waiting in the present embodiment are the same as in the first embodiment.

During the reset-waiting state, once the notification signal REM indicates “there is no unprocessed data” and the processing completion signal DN indicates “processing completed”, the reset/input enable signal generation circuit 64 outputs a reset signal RST to the R/W control circuit 71 and the content encryption/decryption section 32, and cancels the reset-waiting state. At the same time, the reset/input enable signal generation circuit 64 outputs an input enable signal IE which is kept active (input enabled state).

Thus, in accordance with the copyright protective device of the present embodiment, resetting can be properly performed on a regular basis so that proper operation can occur when proper data is inputted, even in the event of an abnormality. Moreover, even if data is inputted after the input enable signal becomes inactive, excessive data can be successfully processed without being lost.

As in the first embodiment, the length and value of the heading pattern may be arbitrary in the present embodiment. Although the present embodiment assumes that one byte of excessive data is inputted, the number of excessive data may be arbitrary. In the case where the number of excessive data is two or more, the number of stages of the input registers and the extended period for the input enable signal IE may be adjusted in accordance with the number of excessive data.

(Eleventh Embodiment)

The eleventh embodiment of the present invention is characterized in that the processing of data after an input enable signal becomes inactive is performed by means of a memory of a FIFO (First In First Out) type or a memory which realizes similar address control.

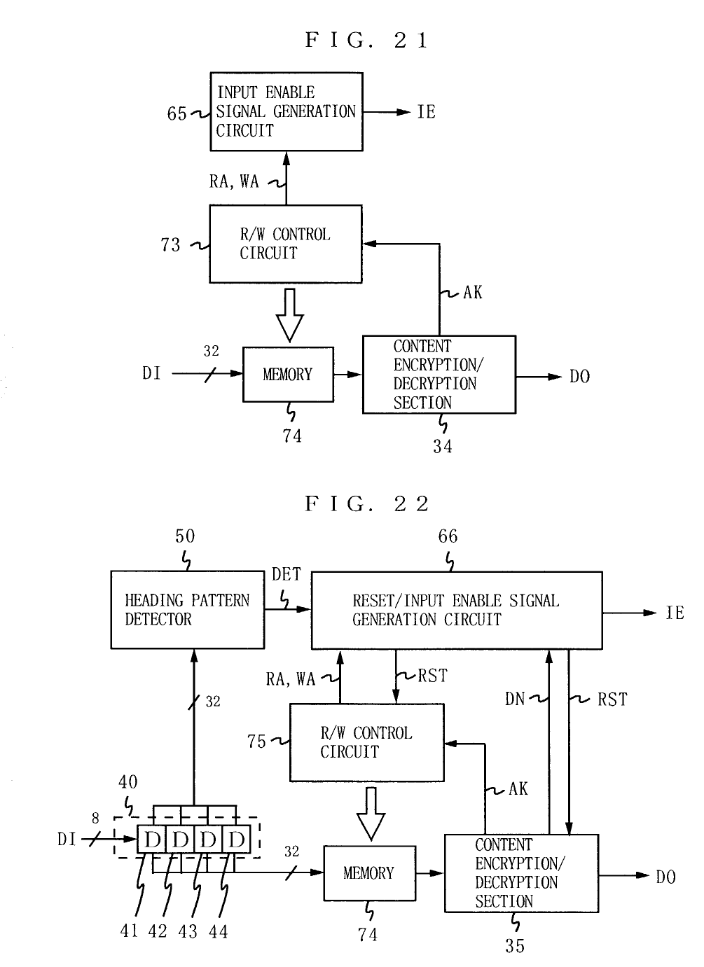

FIG. 21 shows an input enable signal generation circuit 65, a R/W control circuit 73, a memory 74, and a content encryption/decryption section 34 of a copyright protective device according to the present embodiment.

In order to facilitate the understanding of the present embodiment, it is assumed that data is inputted to the content encryption/decryption section 34 in a 4 byte-parallel manner, and that 4 bytes of excessive data is inputted after the input enable signal IE becomes inactive (input disabled state).

Input data DI is sequentially inputted to the memory 74. The content encryption/decryption section 34 applies predetermined processing to the data which has been inputted via the memory 74, and outputs output data DO. In an immediately previous clock cycle to the occurrence of an overflow state in its internal processing, the content encryption/decryption section 34 outputs a notification signal AK for indicating whether or not data is acceptable, which is kept inactive (unacceptable).

The read and write control for the memory 74 is performed by means of the R/W control circuit 73. If input data DI is inputted, the R/W control circuit 73 enables data write. On the other hand, if any data is readable from the memory 74 and the notification signal AK indicates “acceptable”, the R/W control circuit 73 reads the data from the memory 74, and supplies it to the content encryption/decryption section 34. Furthermore, the R/W control circuit 73 outputs a read address RA and a write address WA for the memory 74 to the input enable signal generation circuit 65.

Once the difference between the read address RA and the write address WA equals two, the input enable signal generation circuit 65 outputs an input enable signal IE which is kept inactive (input disabled state) to stop data input. After the input enable signal IE becomes inactive, 4 bytes of excessive data is inputted. However, the memory 74 has a data width of 4 bytes. Therefore, even if the excessive data is written to the memory 74, the read address RA and the write address WA do not take the same value, so that overwriting of any unread data is prevented.

When the read address RA is updated so that the difference between the read address RA and the write address WA exceeds two, the input enable signal generation circuit 65 outputs an input enable signal IE which is kept active (input enabled state). As a result, the 4 bytes of excessive data which is inputted after the input enable signal IE becomes inactive can be successfully processed without being lost.

Thus, in accordance with the copyright protective device of the present embodiment, even if data is inputted after the input enable signal becomes inactive, excessive data can be successfully processed without being lost, as in the tenth embodiment.

It will be appreciated that, as is the case with the other embodiments, the size of one unit of input data, etc., in the present embodiment may be a parameter value other than those assumed herein.

By combining the tenth and eleventh embodiments, a copyright protective device as shown in FIG. 22 can be obtained. The operation of the circuit shown in FIG. 22 is similar to those according to the tenth and eleventh embodiments, and the descriptions thereof are omitted here. This device can take in up to 2 bytes of excessive data which is inputted after the input enable signal IE becomes inactive.

### INDUSTRIAL APPLICABILITY

As described above, firstly, a copyright protective device according to the present invention reduces the generation time for keys which are employed for encryption or decryption; secondly, the copyright protective device according to the present invention does not output unnecessary data during key generation; thirdly, the copyright protective device according to the present invention returns to a normal state as a predetermined pattern is inputted, even in the event of an abnormality; furthermore, the copyright protective device according to the present invention can successfully process any excessive data which is inputted after an input enable signal becomes inactive.

1. A copyright protective device for encrypting or decrypting a content, comprising:
key generation means for generating an intermediate key by using key information which is stored on a medium and in a recording/reproduction device for the medium, and using the intermediate key to generate a key with which to apply cryptographic processing to the content,
cryptographic processing means for applying cryptographic processing to the content by using the key, and
retention means for retaining the intermediate key in a form which is not recognizable as a key.

2. The copyright protective device according to claim 1, wherein,
the key generation means generates said key with respect to each of a plurality of media,
the cryptographic processing means applies cryptographic processing to the content by using the key generated for each medium, and
the retention means retains the intermediate keys generated for the plurality of media in a form which is not recognizable as a key.

3. The copyright protective device according to claim 1, wherein the retention means retains the intermediate key and the key in a storage circuit within integrated circuitry.

4. A copyright protective device for encrypting or decrypting a content, comprising:
key generation means for generating an intermediate key by using key information which is stored on a medium and in a recording/reproduction device for the medium, and using the intermediate key to generate a key with which to apply cryptographic processing to the content,
cryptographic processing means for applying cryptographic processing to the content by using the key, and
retention means for retaining the intermediate key in an encrypted manner.

5. The copyright protective device according to claim 4, wherein,
the key generation means generates said key with respect to each of a plurality of media,
the cryptographic processing means applies cryptographic processing to the content by using the key generated for each medium, and
the retention means retains the intermediate keys generated for the plurality of media in an encrypted manner.

6. A copyright protective device for encrypting or decrypting a content, comprising:
key generation means for generating a key with which to apply cryptographic processing to the content and an intermediate key for generating the key, by sequentially extracting necessary data from key generation data which is formed in a matrix and applying computation processing thereto,
cryptographic processing means for applying cryptographic processing to the content by using the key, and
retention means for retaining at least one of the intermediate key and the key generation data.

7. The copyright protective device according to claim 6, wherein,
the key generation means generates said key with respect to each of a plurality of media,
the cryptographic processing means applies cryptographic processing to the content by using the key generated for each medium, and
the retention means retains the intermediate key and the key generation data with respect to each medium.

8. A copyright protective method for encrypting or decrypting a content, comprising:
a key generation step of generating an intermediate key by using key information which is stored on a medium and in a recording/reproduction device for the medium, and using the intermediate key to generate a key with which to apply cryptographic processing to the content,
an cryptographic processing step of applying cryptographic processing to the content by using the key, and
a retention step of retaining the intermediate key in a form which is not recognizable as a key.

9. The copyright protective method according to claim 8, wherein,
the key generation step generates said key with respect to each of a plurality of media,
the cryptographic processing step applies cryptographic processing to the content by using the key generated for each medium, and
the retention step retains the intermediate keys generated for the plurality of media in a form which is not recognizable as a key.

10. A copyright protective method for encrypting or decrypting a content, comprising:
a key generation step of generating an intermediate key by using key information which is stored on a medium and in a recording/reproduction device for the medium, and using the intermediate key to generate a key with which to apply cryptographic processing to the content,
an cryptographic processing step of applying cryptographic processing to the content by using the key, and
a retention step of retaining the intermediate key in an encrypted manner.

11. A copyright protective method for encrypting or decrypting a content, comprising:
a key generation step of generating a key with which to apply cryptographic processing to the content and an intermediate key for generating the key, by sequentially extracting necessary data from key generation data which is formed in a matrix and applying computation processing thereto,
an cryptographic processing step of applying cryptographic processing to the content by using the key, and
a retention step of retaining at least one of the intermediate key and the key generation data.

12. The copyright protective method according to claim 11, wherein,
the key generation step generates said key with respect to each of a plurality of media,
the cryptographic processing step applies cryptographic processing to the content by using the key generated for each medium, and
the retention step retains the intermediate key and the key generation data with respect to each medium.

13. A copyright protective device for encrypting or decrypting a content, comprising:
key generation means for generating a key with which to apply cryptographic processing to the content and outputting a notification signal which indicates whether key generation is being performed or not, and
cryptographic processing means, to which a content containing identification information indicating whether or not to perform cryptographic processing is inputted, for applying cryptographic processing to the content in accordance with the identification information by using the key, and for outputting a result of the cryptographic processing,
wherein the cryptographic processing means restrains the result of the cryptographic processing from being outputted when the notification signal indicates that key generation is being performed.

14. A copyright protective device for encrypting or decrypting a content, comprising:
key generation means for generating a key with which to apply cryptographic processing to the content and outputting a notification signal which indicates whether key generation is being performed or not,
cryptographic processing means, to which a content containing an identification signal indicating whether or not to perform cryptographic processing is inputted, for applying cryptographic processing to the content in accordance with the identification signal by using the key, and for outputting a result of the cryptographic processing, and
selection means for selecting a content which is inputted to the cryptographic processing means when the notification signal indicates that key generation is being performed, and otherwise selecting the result of the cryptographic processing outputted from the cryptographic processing means.

15. A copyright protective device for encrypting or decrypting a content, comprising:
key generation means for generating a key with which to apply cryptographic processing to the content and outputting a notification signal which indicates whether key generation is being performed or not, and
cryptographic processing means, to which a content containing an identification signal indicating whether or not to perform cryptographic processing is inputted, for applying cryptographic processing to the content in accordance with the identification signal by using the key, and for outputting a result of the cryptographic processing,
wherein, when the notification signal indicates that key generation is being performed, the cryptographic processing means switches an input enable signal for controlling inputting of contents to an input disabled state.

16. A copyright protective device for encrypting or decrypting a content, comprising:
key generation means for generating a key with which to apply cryptographic processing to the content, and
cryptographic processing means, to which a content containing an identification signal indicating whether or not to perform cryptographic processing is inputted, for applying cryptographic processing to the content in accordance with the identification signal by using the key, and for outputting a result of the cryptographic processing,
wherein, when key generation is being performed, the key generation means switches an input enable signal for controlling inputting of contents to an input disabled state.

17. A signal processing device for processing an input signal containing per plurality of symbols a heading pattern which represents a heading of a processing unit, comprising:
a register for retaining the input signal which is sequentially inputted,
heading pattern detection means for detecting the heading pattern being contained in the input signal retained in the register,
signal processing means for applying predetermined signal processing to the input signal which is supplied via the register, and notifying whether the input signal is being processed or not, and
control signal generation means which outputs a reset signal to the signal processing means if the signal processing means is not performing processing when the heading pattern is detected by the heading pattern detection means, and if the signal processing means is performing processing when the heading pattern is detected by the heading pattern detection means, switches an input enable signal for controlling input to an input disabled state and transitions to a reset-waiting state, and outputs a reset signal to the signal processing means when the processing by the signal processing means is completed in the reset-waiting state.

18. A signal processing device for processing an input signal which is inputted symbol by symbol in accordance with an input enable signal,
signal processing means to which not more than c symbols of said input signal is inputted after the input enable signal changes to an input disabled state, wherein the signal processing means processes b symbols of said signal at one time and notifies an overflow state of internal processing,
input enable signal generation means for switching the input enable signal to an input disabled state when the processing by the signal processing means enters an overflow state, and
a register which retains a symbols of said input signal, outputs b symbols to the signal processing means when the input enable signal is in an input enabled state, wherein a, b, and c are of the relationship a≧(b+c), and employs as a load signal a logical OR signal between the input enable signal and a signal obtained by delaying the signal by one clock cycle.

19. A signal processing device for processing an input signal which is inputted symbol by symbol in accordance with an input enable signal,
signal processing means to which not more than c symbols of said input signal is inputted after the input enable signal changes to an input disabled state, wherein the signal processing means applies predetermined processing to the input signal and notifies whether the input signal is acceptable or not,
a memory for storing the input signal and outputting the stored input signal to the signal processing means,
memory control means which, if the input signal is acceptable to the signal processing means, controls the memory so that the data is read therefrom, and outputs a write address and a read address while performing write control so as not to overwrite data on any unread data, and
input enable signal generation means for switching the input enable signal to an input disabled state when a write margin which is calculated based on the write address and the read address outputted from the memory control means reaches at least c symbols.
